(19) United States
(12) Patent Application Publication
(10) Pub. No.: US 2021/0269579 A1
(43) Pub. Date: Sep. 2, 2021

(54) Process for Producing a Rigid polyurethane Foam and use Thereof as an Insulation Material

(71) Applicant: BASF SE, Ludwigshafen am Rhein (DE)

(72) Inventors: Hendrik WAGNER, Lemfoerde (DE); Marko Grever, Lemfoerde (DE); Frank Thielbeer, Lemfoerde (DE); Sabrina Kronig, Lemfoerde (DE); Antje Huskobla, Lemfoerde (DE); Joerg Krogmann, Lemfoerde (DE); Dejan Petrovic, Lemfoerde (DE)

(73) Assignee: BASF SE, Ludwigshafen am Rhein (DE)

(21) Appl. No.: 17/250,256

(22) PCT Filed: Jun. 19, 2019
(86) PCT No.: PCT/EP2019/066252

§ 371 Date: Dec. 22, 2020

(30) Foreign Application Priority Data
Jun. 27, 2018 (EP) 18180189.5

(51) Int. Cl. C08G 18/63; C08G 18/48; C08G 18/40; C08G 18/22; C08G 18/20; C08G 18/08; C08J 9/14

(52) U.S. Cl. CPC C08G 18/638; C08G 18/482; C08G 18/409; C08G 18/4072; C08G 18/227; C08G 18/2036; C08J 2203/14; C08J 9/141; C08G 2110/0025; C08G 2330/00; C08J 2375/08; C08J 2205/10; C08G 18/14

(57) ABSTRACT

A process is useful for producing a rigid polyurethane foam, also referred to as rigid PU foam, via mixing of three streams, rigid PU foams that are obtained by that process, and the use thereof as an insulation material.

The present invention relates to a process for producing a rigid polyurethane foam, also referred to as rigid PU foam, via mixing of three streams, rigid PU foams that are obtained by that process, and the use thereof as an insulation material for either heating or cooling applications, such as for appliances, for buildings, as insulation boards, water heaters, pipes, refrigerators as well as freezers, transport boxes, and batteries, trucks or trailers.

### BACKGROUND OF THE INVENTION

Rigid PU foams have been known for a long time, and are used for thermal insulation in the appliance or construction industry, such as in refrigerators, freezers, water heaters, insulation boards, etc.

Usually producers of PU rigid foams and in particular producer of refrigerators source the polyol containing component (component A)) and the isocyanate component (component B)) as ready to use mixtures from the suppliers of polyols and polyisocyanates. Components A) and B) are carefully designed by these suppliers to fulfil the requirement profiles of the PU foam producers and contain carefully selected combination of ingredients, like different polyols, catalysts, blowing agents, surfactants etc. Components A) and B) need to show long-term stability to allow the transport of the components from the supplier to the PU foam producer and their storage at the facilities of the PU foam producers. Raw materials of rigid PU foams are selected with respect to their compatibility, so that stable homogeneous formulations can be obtained. Thus, the best possible shelf life of the formulation is targeted. Accordingly, the raw materials are tuned to fulfil this criterion. The requirement of long-term stability limits the selection of compounds to be used in components A) and B), since compounds leading to phase separation and/or chemical degradation cannot be added to components A) and B) at the production sites of the supplier. One example of such compounds are polymer polyols which are often not miscible with other polyols resulting in phase separated mixtures which could not be stored or processed, since this would lead to inhomogeneous foams and to problems with the equipment like clogging of pumps etc.

DE 3612125 A1 discloses a process for producing PU foam components which is a high-pressure process and comprises a first component containing a polyol, a second component containing an isocyanate and a third component containing a pressure-sensitive and heat-sensitive substance being fed continuously, in closed circuits in each case, to a mixing head. However, the patent application does not addressfabrication of PU rigid foams for insulation applications and is silent about the incompatibility of the different components.

WO 99/60045 A1 describes a polyol blend comprising a polyol component and a polymer polyol comprising a polymer stably dispersed in a base polyol medium for preparing open cell rigid polyurethane foams. In example 3 a polyurethane foam laminate was prepared by combining four feed streams being a) a polyol blend containing polyol A and B and a polymer polyol comprising a polymer stably dispersed in polyol A and/or B; a first catalyst feed containing catalyst 1 and polyol B, c) a second catalyst feed containing catalyst 2 and polyol B and d) an isocyanate feed stream. Feed streams a), b) and c) are compatible with each other and do not undergo phase separation or chemical degradation as shown in the experimental part below.

WO 2004/035650 discloses a process for the preparation of rigid PU foams offering good demold performance, noticeable as low post expansion of the foam after demolding, and curing behavior. A polyol component which is based at least partially on polymer polyols, also known as graft polyols, is used. However, the miscibility of the polymer polyols with other polyols and blowing agents is very poor. A homogeneous and storage-stable component cannot be obtained which prevents machine processing and production on an industrial scale.

In WO 2005/097863 a process for the use of polymer polyols in rigid polyurethane foams is described. These polyols have a high content of ethylene oxide to improve the miscibility. However, the application of polymer polyols in this case leads to lower performance regarding the demold performance.

EP 1 108 514 as well as JP 11060651 disclose a process for the preparation of polyurethane rigid foam panels using polymer polyols. The polyols that are used in the formulation have a high content of ethylene oxide in order to improve the miscibility of the polymer polyols. These polyurethane rigid foams offer a low shrinkage behavior. However, the use of high levels of ethylene oxide in the polymer polyols leads to significant disadvantages, e.g. a low solubility of the polymer polyol with hydrocarbons, which are commonly used as blowing agents. Furthermore, such polyols have an increased intrinsic reactivity which prevents the controlled formation of polyurethane by means of catalysis.

EP 2 066717 discloses a process for producing rigid PU foams in which the polyol component comprises a polymer polyol designed specifically for rigid foam applications which is based on a lower limit of the hydroxyl value. A disadvantage is that only a limited proportion of styrene can be incorporated into the polymer polyol, since otherwise the phase stability cannot not be guaranteed.

JP 2000 169541 describes rigid PU foams with improved mechanical strength and reduced shrinkage. The particles used for the polymer polyols are based on acrylonitrile only. Hence, only a limited set of polymer polyols is available which leads to lower performance.

US 2006/0058409 A1, US 2007/0259981 A1 and U.S. Pat. No. 8,293,807 B2 disclose process for producing rigid PU foams with or without a polymer polyol. These rigid PU foams have been described for thermal insulation, e.g. in refrigeration equipment, and are produced in a two-component system, wherein a reaction mixture comprising a polyol component having isocyanate reactive groups, additives, catalysts, blowing agents and stabilizers, is mixed with an isocyanate component.

The systems that are described in the prior art have severe limitations. The presence of incompatible and immiscible compounds in the reaction mixture of the two-component system, either results in phase separation or chemical degradation. For instance, the polyol blends comprising polymer polyols, in combination with other polyols, isocyanates, blowing agents and catalysts, result in an immiscible or poorly miscible reaction mixture that either cannot be processed on an industrial scale, or if it was processed on an industrial scale, would lead to impaired performance characteristics such as an inadequate demolding behavior which is evident by prolonged cycle time and significant post expansion of the rigid PU foam.

The use of an external compatibilizer for improving the shelf life of at least two mutually immiscible polyols and the use of the compatibilized polyol mixture to produce rigid PU foams and/or rigid polyisocyanurate foams is disclosed in US 2010/0240786 A1. However, such compatibilizers can also visibly influence the properties of the resulting foam.

Thus, it was an object of the invention to provide a processing technique for obtaining rigid PU foams, wherein phase separation or chemical degradation due to incompatible and/or immiscible mixture of the components is prevented, while the resulting foam shows improved demold behavior (noticeable as low post expansion of the foam after demolding), mechanical performance and/or improved thermal conductivities without compromising on other advantageous properties of rigid PU foams that are used as an insulation material, such as but not limited to, compressive strength, adhesion, low brittleness and flowability. Furthermore, the process should allow the use of compounds in the preparation of PU foams which would lead to phase separation and/or chemical degradation in case they are mixed either with the polyol containing component A) and/or with the isocyanate containing component B).

### SUMMARY OF THE INVENTION

Surprisingly, it was found that phase separation or chemical degradation due to an incompatible and immiscible mixture of the components of the rigid PU foam is prevented, while the resulting PU foam shows improved demold behavior, mechanical performance and/or improved thermal conductivities by providing a process for producing rigid PU foam which comprises at least the step of preparing a reaction mixture of the components by feeding at least three separated streams into a mixing device.

Accordingly, in one aspect, the present invention is directed to a process for producing a rigid PU foam comprising at least the step of:

(S1) preparing a reaction mixture by feeding at least three separated streams into a mixing device, wherein
(A) a first stream comprises at least one component A), wherein component A) comprises at least one first isocyanate reactive compound,
(B) a second stream comprises at least one component B), wherein component B) comprises at least one isocyanate, and
(C) a third stream comprises at least one component C) which is different from both components A) and B),
wherein at least one blowing agent and at least one catalyst is present in at least one of the components A), B) and C), and

whereby mixing of component C) with A) and/or B) leads to phase separation or chemical degradation.

In another aspect, the present invention is directed to a rigid PU foam obtained by the above-mentioned process.

In another aspect, the present invention is directed to the use of the above mentioned rigid PU foam as insulation material.

In still another aspect, the present invention is directed to the use of a polymer polyol for preparation of the rigid PU foam by the above-mentioned process.

In yet another aspect, the present invention is directed to insulation boards, water heaters, pipes, refrigerators, freezers, transport boxes, batteries, trucks or trailers comprising the above mentioned rigid PU foam or the rigid PU foam that is prepared by the above-mentioned process.

In still another aspect, the present invention is directed to a method of insulating an enclosed space comprising the step of applying the above mentioned rigid PU foam or the rigid PU foam that is prepared by the above-mentioned process.

### DETAILED DESCRIPTION OF THE INVENTION

Before the present compositions and formulations of the invention are described, it is to be understood that this invention is not limited to particular compositions and formulations described, since such compositions and formulation may, of course, vary. It is also to be understood that the terminology used herein is not intended to be limiting, since the scope of the present invention will be limited only by the appended claims.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the appended claims, any of the claimed embodiments can be used in any combination.

Furthermore, the ranges defined throughout the specification include the end values as well, i.e. a range of 1 to 10 implies that both 1 and 10 are included in the range. For the avoidance of doubt, the applicant shall be entitled to any equivalents according to applicable law.

An aspect of the present invention describes a process for producing a rigid PU foam comprising at least the step of:

(S1) preparing a reaction mixture by feeding at least three separated streams into a mixing device, wherein
(A) a first stream comprises at least one component A), wherein component A) comprises at least one first isocyanate reactive compound,
(B) a second stream comprises at least one component B), wherein component B) comprises at least one isocyanate, and
(C) a third stream comprises at least one component C) which is different from both components A) and B),
wherein at least one blowing agent and at least one catalyst is present in at least one of the components A), B) and C), and

whereby mixing of component C) with A) and/or B) leads to phase separation or chemical degradation.

For the purpose of the present invention, phase separation or chemical degradation occurs due to an incompatible and/or immiscible mixture of the components that are present in the component C) with the components A) and/or B). Accordingly, the component C) comprises at least one compound which is incompatible or immiscible in mixture with component A) and/or B). The disadvantages which are caused by the incompatibility or immiscibility of the components are prevented in the present invention by feeding at least three separate streams into the mixing device.

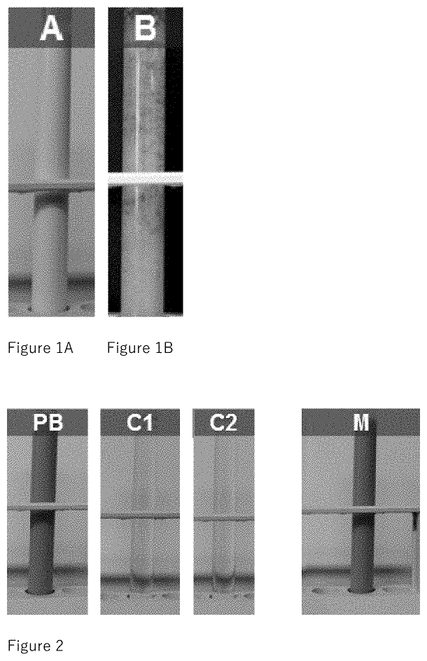

As known to the person skilled in the art of PU rigid foams and their preparation the components A), B) and possibly further components include not only homogenous solutions or mixtures of the different compounds but also stable multiphase mixtures of the compounds like stable emulsions and suspensions, wherein in the different phases are homogenously distributed. A typical example for such a stable multiphase mixture is a polymer polyol wherein a solid grafted polymer is dispersed in a liquid polyol, often by means of a stabilizer. Phase separation of such multiphase mixtures manifests themselves by macroscopic phase separation, e.g. by flocculation, coagulation or precipitation, resulting in an inhomogeneous mixture of the different compounds and/or phases. In FIG. 1 an example of a non-phase separated, homogenous and stable multiphase mixture (FIG. 1A) as well as an example of a phase separated, inhomogeneous multiphase mixture (FIG. 1B) are shown. According to the present invention, the phase separation is determined visually by mixing of component C) with A) and/or B). Phase separation may be visible immediately upon mixing or within a period up to 15 days after the reaction mixture is obtained and stored at room temperature. According to the present invention mixing of component C) with A) and/or B) is considered as leading to phase separation in case phase separation is visually detectable directly after mixing or within 7 days after mixing and storage at room temperature. The term “room temperature”, as used hereinabove or hereinbelow, refers to a temperature of 25° C. The term “visually detectable” means detectable the human eye.

According to the present invention, chemical degradation occurring due to an incompatible and immiscible mixture of the components results in the change of the structure and/or properties of the components that are contained in the mixture due to the presence of a reactive chemical agent in the mixture and/or the external factors such as light, heat or electricity. Chemical degradation can be observed, for example by variation of string time/gel time, free rise density, water content, OH value, amine value, NCO content or color changes. Preferably chemical degradation of the mixture can be considered to have occurred when at least one of the following parameters of the mixture varies beyond the value provided hereinbelow, preferably within a period of 4 weeks after measuring the corresponding initial value:

| | |
|---|---|
| String time/gel time of the reaction mixture | ±6% |
| Free rise density of the cured foam | ±5% |
| Water content of the premixed components | ±5% |
| OH value of the premixed components | ±6% |
| Amine value of the premixed components | ±6% |
| NCO content of the premixed components | ±2% |

These variations are measured against their corresponding initial values, i.e. the value that is measured shortly after preparation of the mixture by any conventional means including, but not limited to, manual stirring.

String time/gel time can be measured by dipping for example a stick into the rising foam every few seconds to determine the time from the beginning until the formation of strings. Free rise density can be determined by allowing the foaming polyurethane reaction mixture to expand in a plastic bag at room temperature. The density is determined on a cube removed from the center of the foam-filled plastic bag. These techniques are well known to the person skilled in the art and therefore do not limit the present invention. Water content can be determined by DIN 51777, OH value by DIN 53240, amine value by DIN 16945 and NCO content by DIN EN ISO 14896.

As used herein, the term “respective component” refers to at least one of the components A), B) and C), as described hereinabove or hereinbelow. Further, sum of wt.-% of all the compounds, as described hereinbelow, in the respective component adds up to 100 wt.-%.

For the sake of completeness, the reaction of an isocyanate reactive compound with isocyanate is not considered as chemical degradation in the sense of the term “chemical degradation” as defined herein.

The present process is suited in cases wherein phase separation and/or chemical degradation occurs instantaneously after mixing component C) with component A) and/or B) and also in cases wherein phase separation and/or chemical degradation occurs within 1 hour or within 1 day after mixing component C) with component A) and/or B). But the present process is also suited for the processing of components wherein a phase separation and/or chemical degradation occurs after 1, 2, 3 or 4 weeks after mixing and therefore takes into account the needs of the current delivery and production processes in the PU foam business wherein the components are obtained as ready to use mixtures which survive shipment and a certain storage time without effecting detrimentally the processability components and quality of the PU foam.

Component A)

The first stream comprises at least one component A), wherein the component A) comprises at least one first isocyanate reactive compound. In an embodiment, the first isocyanate reactive compound is at least one polyol selected from the group consisting of polyether polyols, polyester polyols, polyether-ester polyols and mixtures thereof.

Furthermore, component A) may further comprise generally known compounds commonly used to produce rigid foams, for example at least one compound selected from the group consisting of blowing agents, catalysts, stabilizers, additives and mixtures thereof. Depending on the specific application, chain extenders and/or cross linkers might be present in addition. Of course, various combinations of these compounds can be present as different embodiments within component A).

Suitable polyether polyols, polyester polyols, polyether-ester polyols and examples of blowing agents, catalysts, stabilizers, additives, chain extenders and/or cross linkers are described herein below.

Isocyanate Reactive Compounds

The isocyanate reactive compounds include the compounds in the reaction mixture which have free hydroxyl groups present therein, irrespective of the components wherein they can be present, and are reactive towards isocyanate. That is, to say, that the isocyanate reactive compounds can be present in any components, such as but not limited to A) and C).

In a preferred embodiment, the isocyanate reactive compounds are polyols having an average functionality in between 2.0 to 8.0 and hydroxyl numbers in between 15 mg KOH/g to 1800 mg KOH/g.

In a more preferred embodiment, the isocyanate reactive compounds are selected from the group consisting of polyether polyols, polyester polyols and polyether ester polyols.

In an even more preferred embodiment, the first isocyanate reactive compounds are polyether polyols having a hydroxyl number in between 15 mg KOH/g to 500 mg KOH/g.

In a most preferred embodiment, the first isocyanate reactive component is a mixture of polyether polyols. The mixture comprises a polyether polyol (i) having an average functionality in between 4.0 to 8.0 and a hydroxyl number in between 300 mg KOH/g to 500 mg KOH/g, and a polyether polyol (ii) having an average functionality in between 2.0 and 5.0 and a hydroxyl number between 56 mg KOH/g to 290 mg KOH/g. The polyether polyols (i) and (ii) are selected from the preferred embodiments of the polyether polyols listed herein below.

Suitable isocyanate reactive compounds are described herein below.

Polyether Polyol

Polyether polyols according to the invention preferably have an average functionality in between 2.0 to 8.0, more preferably in between 2.5 to 6.5, and preferably a hydroxyl number in between 15 mg KOH/g to 500 mg KOH/g.

In an embodiment, the polyether polyols are obtainable by known methods, for example by anionic polymerization with alkali metal hydroxides, e.g., sodium hydroxide or potassium hydroxide, or alkali metal alkoxides, e.g., sodium methoxide, sodium ethoxide, potassium ethoxide or potassium isopropoxide, as catalysts and by adding at least one amine-containing starter molecule, or by cationic polymerization with Lewis acids, such as antimony pentachloride, boron fluoride etherate and so on, or fuller's earth, as catalysts from one or more alkylene oxides having 2 to 4 carbon atoms in the alkylene moiety.

Starter molecules are generally selected such that their average functionality is preferably in between 2.0 to 8.0, more preferably in between 3.0 to 8.0 depending on their function and use in the rigid PU foam application. Optionally, a mixture of suitable starter molecules is used.

Starter molecules for polyether polyols include amine containing and hydroxyl-containing starter molecules. Suitable amine containing starter molecules include, for example, aliphatic and aromatic diamines such as ethylenediamine, propylenediamine, butylenediamine, hexamethylenediamine, phenylenediamines, toluenediamine, diaminodiphenylmethane and isomers thereof.

Other suitable starter molecules further include alkanolamines, e.g. ethanolamine, N-methylethanolamine and N-ethylethanolamine, dialkanolamines, e.g., diethanolamine, N-methyldiethanolamine and N-ethyldiethanolamine, and trialkanolamines, e.g., triethanolamine, and ammonia.

Preferred amine containing starter molecules are selected from the group consisting of ethylenediamine, phenylenediamines, toluenediamine and isomers thereof. Particularly preferred is a vicinal toluenediamine mixture. Vicinal toluenediamine mixtures are by-products of the manufacture of non-vicinal toluenediamines, for e.g. as described in U.S. Pat. No. 3,420,752.

Hydroxyl-containing starter molecules are selected from the group consisting of sugars and sugar alcohols, for e.g. glucose, mannitol, sucrose, pentaerythritol, sorbitol; polyhydric phenols, resols, e.g., oligomeric condensation products formed from phenol and formaldehyde, trimethylolpropane, glycerol, glycols such as ethylene glycol, propylene glycol and their condensation products such as polyethylene glycols and polypropylene glycols, e.g., diethylene glycol, triethylene glycol, dipropylene glycol, and water.

Preferred hydroxyl containing starter molecules are sugar and sugar alcohols such as sucrose and sorbitol, glycerol, and mixtures of said sugars and/or sugar alcohols with glycerol, water and/or glycols such as, for example, diethylene glycol and/or dipropylene glycol. More preferred are mixtures of sucrose with one or more than one—preferably one—compound selected from glycerol, diethylene glycol and dipropylene glycol. Most preferred is a mixture of sucrose and glycerol.

Suitable alkylene oxides having 2 to 4 carbon atoms are, for example, ethylene oxide, propylene oxide, tetrahydrofuran, 1,2-butylene oxide, 2,3-butylene oxide and styrene oxide. Alkylene oxides can be used singly, alternatingly in succession or as mixtures. Preferred alkylene oxides are propylene oxide and/or ethylene oxide, while mixtures of ethylene oxide and propylene oxide that comprise more than 50 wt.-% of propylene oxide are more preferred.

The amount of the polyether polyols is preferably in between 1 wt.-% to 99 wt.-%, based on the total weight of the respective component, preferably based on the total weight of component A). More preferably, it is in between 15 wt.-% to 99 wt.-%. Most preferably, it is in between 20 wt.-% to 98 wt.-%.

Polyester Polyol

The polyester polyols preferably have an average functionality in between 2.0 to 6.0, more preferably in between 2.0 to 5.0, most preferably between 2.0 to 4.0 and preferably a hydroxyl number in between 30 mg KOH/g to 250 mg KOH/g, more preferably in between 100 mg KOH/g to 200 mg KOH/g.

Polyester polyols according to the present invention are based on the reaction product of carboxylic acids or anhydrides with hydroxy group containing compounds. Suitable carboxylic acids or anhydrides have from 2 to 20 carbon atoms, preferably from 4 to 18 carbon atoms, for example succinic acid, glutaric acid, adipic acid, suberic acid, azelaic acid, sebacic acid, decanedicarboxylic acid, maleic acid, fumaric acid, phthalic acid, isophthalic acid, terephthalic acid, oleic acid, phthalic anhydride. Particularly selected from the group consisting of phthalic acid, isophthalic acid, terephthalic acid, oleic acid and phthalic anhydride.

Suitable hydroxy containing compounds are selected from the group consisting of ethanol, ethylene glycol, propylene-1,2-glycol, propylene-1,3-glycol, butyl-ene-1,4-glycol, butylene-2,3-glycol, hexane-1,6-diol, octane-1,8-diol, neopentyl glycol, cyclohexane dimethanol (1,4-bis-hydroxymethyl-cyclohexane), 2-methyl-propane-1,3-diol, glycerol, trimethylolpropane, hexane-1,2,6-triol, butane-1,2,4-triol, trimethylolethane, pentaerythritol, quinitol, mannitol, sorbitol, methyl glycoside, diethylene glycol, triethylene glycol, tetraethylene glycol, polyethylene glycol, dipropylene glycol, polypropylene glycol, polyethylene-propylene glycol, dibutylene glycol and polybutylene glycol. Preferably, hydroxy containing compounds are selected from the group consisting of ethylene glycol, propylene-1,2-glycol, propylene-1,3-glycol, butyl-ene-1,4-glycol, butylene-2,3-glycol, hexane-1,6-diol, octane-1,8-diol, neopentyl glycol, cyclohexane dimethanol (1,4-bis-hydroxy-methylcyclohexane), 2-methyl-propane-1,3-diol, glycerol, trimethylolpropane, hexane-1,2,6-triol, butane-1,2,4-triol, trimethylolethane, pentaerythritol, quinitol, mannitol, sorbitol, methyl glycoside and diethylene glycol. More preferably, hydroxy containing compounds are selected from the group consisting of ethylene glycol, propylene-1,2-glycol, propylene-1,3-glycol, butyl-ene-1,4-glycol, butylene-2,3-glycol, hexane-1,6-diol, octane-1,8-diol, neopentyl glycol and diethylene glycol. Particularly preferred, hydroxy containing compounds are selected from hexane-1,6-diol, neopentyl glycol and diethylene glycol.

The amount of the polyester polyols is preferably in between 1 wt.-% to 99 wt.-%, based on the total weight of the respective component, preferably based on the total weight of component A). More preferably, it is in between 20 wt.-% to 99 wt.-%. Most preferably, it is in between 50 wt.-% to 90 wt.-%.

Polyether-Ester Polyol

The polyether-ester polyols have preferably a hydroxyl number in between 100 mg KOH/g to 460 mg KOH/g, more preferably 150 mg KOH/g to 450 mg KOH/g, most preferably 250 mg KOH/g to 430 mg KOH/g and preferably an average functionality in between 2.3 to 5.0, more preferably in between 3.5 to 4.7.

Such polyether-ester polyols are obtainable as a reaction product of i) at least one hydroxyl-containing starter molecule; ii) of one or more fatty acids, fatty acid monoesters or mixtures thereof; iii) of one or more alkylene oxides having 2 to 4 carbon atoms.

The starter molecules of component i) are generally selected such that the average functionality of component i) is preferably 3.8 to 4.8, more preferably 4.0 to 4.7, even more preferably 4.2 to 4.6. Optionally, a mixture of suitable starter molecules is used.

Preferred hydroxyl-containing starter molecules of component i) are selected from the group consisting of sugars and sugar alcohols (glucose, mannitol, sucrose, pentaerythritol, sorbitol), polyhydric phenols, resols, e.g., oligomeric condensation products formed from phenol and formaldehyde, trimethylolpropane, glycerol, glycols such as ethylene glycol, propylene glycol and their condensation products such as polyethylene glycols and polypropylene glycols, e.g., diethylene glycol, triethylene glycol, dipropylene glycol, and water.

Particular preference for use as component i) is given to sugars and sugar alcohols such as sucrose and sorbitol, glycerol, and mixtures of said sugars and/or sugar alcohols with glycerol, water and/or glycols such as, for example, diethylene glycol and/or dipropylene glycol. Very particular preference is given to mixtures of sucrose with one or more than one—preferably one—compound selected from glycerol, diethylene glycol and dipropylene glycol. A mixture of sucrose and glycerol is very particularly preferred.

Said fatty acid or fatty acid monoester ii) is generally selected from the group consisting of polyhydroxy fatty acids, ricinoleic acid, hydroxyl-modified oils, hydroxyl-modified fatty acids and fatty acid esters based in myristoleic acid, palmitoleic acid, oleic acid, stearic acid, palmitic acid, vaccenic acid, petroselic acid, gadoleic acid, erucic acid, nervonic acid, linoleic acid, α- and γ-linolenic acid, stearidonic acid, arachidonic acid, timnodonic acid, clupanodonic acid and cervonic acid. The fatty acid methyl esters are the preferred fatty acid monoesters. Preferred fatty acids are stearic acid, palmitic acid, linolenic acid and especially oleic acid, monoesters thereof, preferably methyl esters thereof, and mixtures thereof. Fatty acids are preferably used as purely fatty acids. Very particular preference is given to using fatty acid methyl esters such as, for example, biodiesel or methyl oleate.

Biodiesel is to be understood as meaning fatty acid methyl esters within the meaning of the EN 14214 standard from 2010. Principal constituents of biodiesel, which is generally produced from rapeseed oil, soybean oil or palm oil, are methyl esters of saturated C₁₆ to C₁ fatty acids and methyl esters of mono- or polyunsaturated C₁ fatty acids such as oleic acid, linoleic acid and linolenic acid.

Suitable alkylene oxides iii) having 2 to 4 carbon atoms are, for example, ethylene oxide, propylene oxide, tetrahydrofuran, 1,2-butylene oxide, 2,3-butylene oxide and/or styrene oxide. Alkylene oxides can be used singly, alternatingly in succession or as mixtures.

Preferred alkylene oxides are propylene oxide and ethylene oxide, while mixtures of ethylene oxide and propylene oxide that comprise more than 50 wt.-% of propylene oxide are particularly preferred; purely propylene oxide is very particularly preferred.

Blowing Agents

Any of the physical blowing agents known for the production of rigid PU foam can be used in the process. In a preferred embodiment, the blowing agent is selected from the group consisting of hydrocarbon, hydrofluorocarbon, hydrofluoroolefin, hydrochlorofluorocarbon, hydrochlorofluoroolefin, fluorocarbon, dialkyl ether, cycloalkylene ethers and ketones, fluorinated ethers and mixtures thereof.

Examples of suitable hydrochlorofluorocarbons include 1-chloro-1,2-difluoroethane, 1-chloro-2,2-difluoroethane, 1-chloro-1,1-difluoroethane, 1,1-dichloro-1-fluoroethane and monochlorodifluoromethane.

Examples of suitable hydrofluorocarbons include 1,1,1,2-tetrafluoroethane (HFC 134a), 1,1,2,2-tetrafluoroethane, trifluoromethane, heptafluoropropane, 1,1,1-trifluoroethane, 1,1,2-trifluoroethane, 1,1,1,2,2-pentafluoropropane, 1,1,1,3-tetrafluoropropane, 1,1,1,3,3-pentafluoropropane (HFC 245fa), 1,1,3,3,3-pentafluoropropane, 1,1,1,3,3-pentafluoro-n-butane (HFC 365mfc), 1,1,1,4,4,4-hexafluoro-n-butane, 1,1,1,2,3,3,3-heptafluoropropane (HFC 227ea) and mixtures of any of the above.

Suitable hydrocarbon blowing agents include lower aliphatic or cyclic, linear or branched hydrocarbons such as alkanes, alkenes and cycloalkanes, preferably having from 4 to 8 carbon atoms. Specific examples include n-butane, iso-butane, 2,3-dimethylbutane, cyclobutane, n-pentane, iso-pentane, technical grade pentane mixtures, cyclopentane, methylcyclopentane, neopentane, n-hexane, iso-hexane, n-heptane, iso-heptane, cyclohexane, methylcyclohexane, 1-pentene, 2-methylbutene, 3-methylbutene, 1-hexene and any mixture of the above. Preferred hydrocarbons are n-butane, iso-butane, cyclopentane, n-pentane and isopentane and any mixture thereof, in particular mixtures of n-pentane and isopentane, mixtures of cyclopentane and isobutane, mixtures of cyclopentane and n-butane and mixtures of cyclopentane and iso- or n-pentane.

Generally, water or other carbon dioxide-evolving compounds are used together with the physical blowing agents. Where water is used as chemical co-blowing agent, typical amounts are in the range from 0.2 wt.-% to 5 wt.-%, based on the total weight of the respective component, preferably based on the total weight of component A).

Hydrofluoroolefins (HFOs), also known as fluorinated alkenes, that are suitable according to the present invention, are propenes, butenes, pentenes and hexenes having 3 to 6 fluorine substituents, while other substituents such as chlorine can be present, examples being tetrafluoropropenes, fluorochloropropenes, for example trifluoromonochloropropenes, pentafluoropropenes, fluorochlorobutenes, hexafluorobutenes or mixtures thereof. Particularly preferable HFOs are selected from the group consisting of cis-1,1,1,3-tetrafluoropropene, trans-1,1,1,3-tetrafluoropropene, 1,1,1-trifluoro-2-chloropropene, 1-chloro-3,3,3-trifluoropropene, 1,1,1,2,3-pentafluoropropene, in cis or trans form, 1,1,1,4,4,4-hexafluorobutene, 1-bromopentafluoropropene, 2-bromopentafluoropropene, 3-bromopentafluoropropene, 1,1,2,3,3,4,4-heptafluoro-1-butene, 3,3,4,4,5,5,5-heptafluoro-1-pentene, 1-bromo-2,3,3,3-tetrafluoropropene, 2-bromo-1,3,3,3-tetrafluoropropene, 3-bromo-1,1,3,3-tetrafluoropropene, 2-bromo-3,3,3-trifluoropropene, E-1-bromo-3,3,3-trifluoropropene, 3,3,3-trifluoro-2-(trifluoromethyl)propene, 1-chloro-3,3,3-trifluoropropene, 2-chloro-3,3,3-trifluoropropene,1,1,1-trifluoro-2-butene and mixtures thereof.

It is very particularly preferable according to the present invention to use 1-chloro-3,3,3-trifluoropropene (HFO-1233zd) and/or 1,1,1,4,4,4-Hexafluorobutene (HFO-1336mzz) and/or water and/or cyclopentane as blowing agents.

The amount of physical blowing agents, as described hereinabove, is preferably in between 2 wt. % to 70 wt.-%, based on the total weight of the respective component. The more preferred amount of blowing agents in the component A) is in between 2 wt.-% to 30 wt.-%, based on the total weight of the component A).

Catalysts

The polyurethane-forming composition typically will include at least one catalyst for the reaction of the polyol(s) and/or water with the polyisocyanate. Suitable urethane-forming catalysts include those described in U.S. Pat. No. 4,390,645 and in WO 2002/079340. Representative catalysts include tertiary amine and phosphine compounds, metal catalysts such as chelates of various metals, acidic metal salts of strong acids; strong bases, alcoholates and phenolates of various metals, salts of organic acids with a variety of metals, organometallic derivatives of tetravalent tin, trivalent and pentavalent As, Sb and Bi and metal carbonyls of iron and cobalt and mixtures thereof.

Suitable of tertiary amines include, such as triethylamine, tributylamine, N-methylmorpholine, N-ethylmorpholine, N,N, N′,N′-tetramethylethylenediamine, pentamethyl-diethylenetriamine and higher homologues (as described in, for example, DE-A 2,624,527 and 2,624,528), 1,4-diazabicyclo(2.2.2)octane, N-methyl-N′-dimethyl-aminoethylpiperazine, bis-(dimethylaminoalkyl)piperazines, tris(dimethylaminopropyl)hexahydro-1,3,5-triazin, N,N-dimethylbenzylamine, N,N-dimethylcyclohexylamine, N,N-diethyl-benzylamine, bis-(N,N-diethylaminoethyl) adipate, N,N,N′,N′tetramethyl-1,3-butanediamine, N,N-dimethyl-p-phenylethylamine, 1,2-dimethylimidazole, 2-methylimidazole, monocyclic and bicyclic amines together with bis-(dialkylamino)alkyl ethers, such as 2,2-bis-(dimethylaminoethyl)ether. Triazine compounds, such as but not limited to, tris(dimethylaminopropyl)hexahydro-1,3,5-triazin can also be used.

Suitable metal catalysts include metal salts and organometallics selected from the group of tin-, titanium-, zirconium-, hafnium-, bismuth-, zinc-, aluminium- and iron compounds, such as tin organic compounds, preferably tin alkyls, such as dimethyltin or diethyltin, or tin organic compounds based on aliphatic carboxylic acids, preferably tin diacetate, tin dilaurate, dibutyl tin diacetate, dibutyl tin dilaurate, bismuth compounds, such as bismuth alkyls or related compounds, or iron compounds, preferably iron-(II)-acetylacetonate or metal salts of carboxylic acids, such as tin-II-isooctoate, tin dioctoate, titanium acid esters or bismuth-(II)-neodecanoate.

In a preferred embodiment, a mixture of the abovementioned catalysts can also be used.

The amount of catalyst is preferably in between 0.01 wt.-% to 99 wt.-%, based on the total weight of the respective component. The more preferred amount of catalysts in component A) is in between 0.01 wt.-% to 99 wt.-%, based on the total weight of the component A).

Additives

Additives, if present, can be selected from the group consisting of alkylene carbonates, carbonamides, pyrrolidones, fillers, flame retardants, dyes, pigments, IR absorbing materials, UV stabilizers, plasticizers, antistats, fungistats, bacteriostats, hydrolysis control agents, antioxidants, cell regulators and mixtures thereof. Further details regarding additives can be found, for example, in the Kunststoffhandbuch, Volume 7, “Polyurethane” Carl-Hanser-Verlag Munich, 1^{st} edition, 1966 2^{nd} edition, 1983 and 3^{rd} edition, 1993.

These additives can be present preferably in an amount in between 1 wt.-% to 99 wt.-%, based on the total weight of the respective component. The more preferred amount of additives in the component A) is in between 1 wt.-% to 20 wt.-%, based on the total weight of the component A).

Chain Extenders and/or Cross Linkers

If present, suitable chain extenders and/or cross linkers have a molecular weight between 49 g/mol to 499 g/mol. The addition of bifunctional chain extenders, trifunctional and higher-functional cross linkers or, if appropriate, mixtures thereof might be added. Chain extenders and/or cross linkers used are preferably alkanol amines and in particular diols and/or triols having molecular weights preferably in between 60 g/mol to 300 g/mol.

Chain extenders, cross linkers, or mixtures thereof can be used preferably in an amount in between up to 99 wt.-%, preferably up to 20 wt.-%, based on the total weight of the respective component. The more preferred amount of chain extenders and/or cross linkers in the component A) can be up to 20 wt.-%, based on the total weight of the component A).

Component B)

The second stream comprises at least one component B), wherein the component B) comprises at least one isocyanate. In an embodiment, the component B) further comprises at least one compound selected from the group consisting of stabilizers, additives, blowing agents, catalysts and mixtures thereof. Of course, various combinations of these compounds can be present as different embodiments within component B).

The component B) comprises at least one isocyanate. In a preferred embodiment, the at least one isocyanate is an aromatic isocyanate. More preferably, the at least one isocyanate is methylene diphenyl diisocyanate and/or polymeric methylene diphenyl diisocyanate.

Isocyanate

For the purpose of the present invention, the isocyanate preferably has an average functionality of at least 2.0; more preferably in between 2.0 to 3.0; even more preferably in between 2.5 to 3.0; most preferably of 2.7. These isocyanates are preferably selected from the group consisting of aliphatic and aromatic isocyanates. By the term “aromatic isocyanate”, it is referred to molecules having two or more isocyanate groups attached directly and/or indirectly to the aromatic ring. Further, it is to be understood that the isocyanate includes both monomeric and polymeric forms of the aliphatic and aromatic isocyanates. By the term “polymeric”, it is referred to the polymeric grade of the aliphatic and/or aromatic isocyanate comprising, independently of each other, different oligomers and homologues.

In a preferred embodiment, the isocyanate is an aromatic isocyanate selected from the group consisting of toluene diisocyanate; polymeric toluene diisocyanate, methylene diphenyl diisocyanate; polymeric methylene diphenyl diisocyanate; m-phenylene diisocyanate; 1,5-naphthalene diisocyanate; 4-chloro-1; 3-phenylene diisocyanate; 2,4,6-toluylene triisocyanate, 1,3-diisopropylphenylene-2,4-diisocyanate; 1-methyl-3,5-diethylphenylene-2,4-diisocyanate; 1,3,5-triethylphenylene-2,4-diisocyanate; 1,3,5-triisoproply-phenylene-2,4-diisocyanate; 3,3′-diethyl-bisphenyl-4,4′-diisocyanate; 3,5,3′,5′-tetraethyl-diphenylmethane-4,4′-diisocyanate; 3,5,3′,5′-tetraisopropyldiphenylmethane-4,4′-diisocyanate; 1-ethyl-4-ethoxy-phenyl-2,5-diisocyanate; 1,3,5-triethyl benzene-2,4,6-triisocyanate; 1-ethyl-3,5-diisopropyl benzene-2,4,6-triisocyanate, tolidine diisocyanate, 1,3,5-triisopropyl benzene-2,4,6-triisocyanate and mixtures thereof. More Preferred aromatic isocyanates are selected from the group consisting of toluene diisocyanate; polymeric toluene diisocyanate, methylene diphenyl diisocyanate; polymeric methylene diphenyl diisocyanate, m-phenylene diisocyanate; 1,5-naphthalene diisocyanate; 4-chloro-1; 3-phenylene diisocyanate; 2,4,6-toluylene triisocyanate, 1,3-diisopropylphenylene-2,4-diisocyanate and 1-methyl-3,5-diethylphenylene-2,4-diisocyanate. Even more preferred aromatic isocyanates are selected from the group consisting of toluene diisocyanate; polymeric toluene diisocyanate, methylene diphenyl diisocyanate; polymeric methylene diphenyl diisocyanate, m-phenylene diisocyanate and 1,5-naphthalene diisocyanate. Most preferred aromatic isocyanates are selected from the group consisting of toluene diisocyanate; polymeric toluene diisocyanate, methylene diphenyl diisocyanate and polymeric methylene diphenyl diisocyanate. Particularly preferably the isocyanate is methylene diphenyl diisocyanate and/or polymeric methylene diphenyl diisocyanate.

Methylene diphenyl diisocyanate is available in three different isomeric forms, namely 2,2′-methylene diphenyl diisocyanate (2,2′-MDI), 2,4′-methylene diphenyl diisocyanate (2,4′-MDI) and 4,4′-methylene diphenyl diisocyanate (4,4′-MDI). Methylene diphenyl diisocyanate can be classified into monomeric methylene diphenyl diisocyanate and polymeric methylene diphenyl diisocyanate referred to as technical methylene diphenyl diisocyanate. Polymeric methylene diphenyl diisocyanate includes oligomeric species and methylene diphenyl diisocyanate isomers. Thus, polymeric methylene diphenyl diisocyanate may contain a single methylene diphenyl diisocyanate isomer or isomer mixtures of two or three methylene diphenyl diisocyanate isomers, the balance being oligomeric species. Polymeric methylene diphenyl diisocyanate tends to have isocyanate functionalities of higher than 2. The isomeric ratio as well as the amount of oligomeric species can vary in wide ranges in these products. For instance, polymeric methylene diphenyl diisocyanate may typically contain about 30 to 80 wt. % of methylene diphenyl diisocyanate isomers, the balance being said oligomeric species. The methylene diphenyl diisocyanate isomers are often a mixture of 4,4′-methylene diphenyl diisocyanate, 2,4′-methylene diphenyl diisocyanate and very low levels of 2,2′-methylene diphenyl diisocyanate.

In addition, reaction products of polyisocyanates with polyhydric polyols and their mixtures with other diisocyanates and polyisocyanates can also be used.

In a particularly preferable embodiment, the isocyanate is a polymeric methylene diphenyl diisocyanate, as described hereinabove. Commercially available isocyanates available under the tradename, such as but not limited to, Lupranat® from BASF can also be used for the purpose of the present invention.

The preferred amount of isocyanates is such that the isocyanate index is preferably in between 70 to 350, more preferably in between 80 to 300, even more preferably in between 90 to 200, most preferably in between 100 to 150. The isocyanate index of 100 corresponds to one isocyanate group per one isocyanate reactive group.

Component C)

The third stream comprises at least one component C) which is different from both the components A) and B). The component C) comprises compounds which are incompatible or immiscible in the mixture with component A) or component B) or component A) and B). Hence, the mixing of component C) with A) and/or B) leads to phase separation or chemical degradation, preferably component C) comprises compounds which are incompatible or immiscible in the mixture with component A), i.e. mixing component C) with component A) leads to phase separation or chemical degradation.

The incompatibility or immiscibility of the component C) depends on the physical and chemical nature of the components A) and B) which are also present in the reaction mixture. Accordingly, there are components C) which are not compatible and/or not miscible at all with any of the components A) and/or B), e.g. polymer polyol and stabilizers, or there are components C) which are not compatible and/or not miscible with the components A) and/or B) depending on the physical and chemical nature of the components A) and B), e.g. a hydrophilic polyether polyol as component A) cannot be miscible with a hydrophobic polyether polyol as component C).

Hence, these incompatible compounds C) are selected from the group consisting of polymer polyols, polyether polyols, polyester polyols, polyether-ester polyols, stabilizers, additives, isocyanates, catalysts and mixtures thereof, preferably from polymer polyols, polyether polyols, polyester polyols, polyether-ester polyols, stabilizers, additives, catalysts, and mixtures thereof. Of course, various combinations of these compounds can be present as different embodiments within component C).

In the following the specifications of preferred compounds used in component C) refers to the compound(s) which lead to phase separation and/or chemical degradation by mixing it with component A).

In a preferred embodiment, the component C) comprises at least one polymer polyol Preferably the at least one polymer polyol is a styrene-acrylonitrile (SAN) polymer polyol, as described hereinbelow.

In another preferred embodiment, the component C) comprises at least one stabilizer. Preferably the at least one stabilizer is a polydimethyl siloxane or a polysiloxane-polyether copolymer, as described hereinbelow.

In yet another preferred embodiment, the component C) comprises at least one polymer polyol and at least one stabilizer.

In yet another preferred embodiment, the component C) comprises at least one catalyst.

In another preferred embodiment, the component C) comprises at least one polyether polyol.

In yet another preferred embodiment, the component C) comprises at least one polyester polyol.

Furthermore, component C) may also comprise other compatible compounds which can also be present in component A) and/or B) such as blowing agents, polyether polyols, chain extenders and/or cross linkers and additives, described in component A).

Polymer Polyols

According to the invention, polymer polyols are stable dispersions of polymer particles in a polyol and thus are not prone to settling or floating. The polymer particles are chemically grafted to the polyol and act as a better reinforcement filler so that the composition of the polymer may be adjusted to give the desired properties. Polymer polyols have a very low moisture content and thus avoid the problems of wet fillers. The polymers in polymer polyols generally have a low density in comparison to inorganic fillers, such as clays or calcium carbonate.

Suitable polymer polyols are selected from the group consisting of styrene-acrylonitrile (SAN) polymer polyols, polyurea suspension (PHD) polymer modified polyols and polyisocyanate polyaddition (PIPA) polymer modified polyols. Particularly preferred are SAN polymer polyols.

SAN polymer polyols are known in the art and are disclosed in lonescu's Chemistry and Technology of Polyols and Polyurethanes, 2nd Edition, 2016 by Smithers Rapra Technology Ltd. In the SAN polymer polyols, a carrier polyol is the polyol in which the in-situ polymerization of olefinically unsaturated monomers is carried out, while macromers are polymeric compounds which have at least one olefinically unsaturated group in the molecule and are added to the carrier polyol prior to the polymerization of the olefinically unsaturated monomers.

SAN polymer polyols can preferably be used in an amount of up to 100 wt.-%, based on the total weight of the respective component, preferably based on the total weight of component C). More preferably, it is in an amount in between 0.5 wt.-% to 70 wt.-%. Particularly for the production of refrigerators and freezers, it is an amount in between 3 wt.-% to 70 wt.-%. For the production of sandwich components, it is an amount in between 0.5 wt.-% to 35 wt.-%.

The SAN polymer polyols have preferably a hydroxyl number in between 10 mg KOH/g to 200 mg KOH/g. More preferably, the hydroxyl number is in between 10 mg KOH/g to 120 mg KOH/g.

The SAN polymer polyols are usually prepared by free-radical polymerization of the olefinically unsaturated monomers, preferably acrylonitrile and styrene, in a polyether polyol or polyester polyol, usually referred to as carrier polyol, as continuous phase. These polymer polyols are preferably prepared by in-situ polymerization of acrylonitrile, styrene or preferably mixtures of styrene and acrylonitrile, e.g. in a weight ratio of from 90:10 to 10:90 (styrene:acrylonitrile), preferably from 70:30 to 30:70 (styrene:acrylonitrile), using methods analogous to those described in DE 1111394, DE 1222669, DE 1152536 and DE 1152537.

The characteristics of the carrier polyol are determined partly by the desired properties of the final polyurethane material to be formed by the SAN polymer polyol. Carrier polyols are conventional polyols preferably having an average functionality in between 2.0 to 8.0, more preferably 2.0 to 3.0, and preferably a hydroxyl number in between 10 to 800 mg KOH/g, more preferably in between 10 to 500 mg KOH/g, even more preferably in between 10 to 300 mg KOH/g, most preferably in between 10 to 200 mg KOH/g.

In an embodiment, the carrier polyol can be a polyether polyol. Starter substance that are used include polyfunctional alcohols such as glycerol, trimethylolpropane or sugar alcohols such as sorbitol, sucrose or glucose, aliphatic amines, such as ethylenediamine, or aromatic amines such as toluenediamine (TDA), diphenylmethanediaimine (MDA) or mixtures of MDA and polyphenylene-polymethylenepolyamines. As alkylene oxides, use is made of propylene oxide or mixtures of ethylene oxide and propylene oxide. Such SAN polymer polyols have a solid content in between 10 wt.-% to 60 wt.-%, based on the total weight of the SAN polymer polyol.

In another embodiment, polyether polyols that are preferably having an average functionality in between 2.0 to 8.0, and a hydroxyl number in between 10 to 100 mg KOH/g are employed as carrier polyols. These polyether polyols are prepared by the addition of alkylene oxides onto H-functional starter substances, for example glycerol, trimethylolpropane or glycols, such as ethylene glycol or propylene glycol. As catalysts for the addition reaction of the alkylene oxides, it is possible to use bases, preferably hydroxides of alkali metals, or multimetal cyanide complexes, known as DMC catalysts.

In an embodiment, mixtures of at least two polyols, in particular at least two polyether polyols, can also be used as carrier polyols.

In order to initiate the free-radical polymerization, well known free-radical polymerization initiators, such as but not limited to, peroxides, azo compounds, persulfates, perborates and percarbonates can be used. Suitable free-radical polymerization initiators can be selected from the group consisting of dibenzoyl peroxide, lauroyl peroxide, t-amyl peroxy-2-ethylhexanoate, di-tert-butyl peroxide, diisopropyl peroxide carbonate, tert-butyl peroxy-2-ethylhexanoate, tert-butyl perpivalate, tert-butyl perneodecanoate, tert-butyl perbenzoate, tert-butyl percrotonate, tert-butyl perisobutyrate, tert-butyl peroxy-1-methylpropanoate, tert-butyl peroxy-2-ethylpentanoate, tert-butyl peroxyoctanoate and di-tert-butyl perphthalate, 2,2′-azobis(2,4-dimethylvaleronitrile), 2,2′-azobisisobutyronitrile (AIBN), dimethyl-2,2′-azobisisobutyrate, 2,2′-azobis(2-methylbutyronitrlle) (AMBN), 1,1′-azobis(1-cyclohexanecarbonitrlle) and mixtures thereof.

Moderators, also referred to as chain transfer agents, can also be used for preparing SAN polymer polyols. The use and the function of these moderators is described, for example, in U.S. Pat. No. 4,689,354, EP 0 365 986, EP 0 510 533 and EP 0 640 633, EP 008 444, EP 0731 118. The moderators effect a chain transfer of the growing free radical and, thus, reduce the molecular weight of the copolymers being formed, as a result of which crosslinking between the polymer molecules is reduced, which influences the viscosity and the dispersion stability and also the filterability of the SAN polymer polyols. Moderators which are typically used for preparing SAN polymer polyols are alcohols such as 1-butanol, 2-butanol, isopropanol, ethanol, methanol, cyclohexanol, toluene, ethylbenzene, mercaptans, such as ethanethiol, 1-heptanethiol, 2-octanethiol, 1-dodecanethiol, thiophenol, 2-ethylhexyl thioglycolate, methyl thioglycolate, cyclohexyl mercaptan, halogenated hydrocarbons, such as carbon tetrachloride, carbon tetrabromide, chloroform, methylene chloride and also enol ether compounds, morpholines, α-(benzoyloxy) styrene and mixtures thereof.

Organic solvents can also be employed for producing the SAN polymer polyols. Organic solvents allow the reduction of the viscosity during the process. Examples of organic solvents are methanol, ethanol, 1-propanol, iso-propanol, butanol, 2-butanol, iso-butanol, and the like. Organic solvents may be used by oneself and/or as mixtures of two or more organic solvents.

Macromers are linear or branched polyols which have number average molecular weights of at least 1000 g/mol and comprise at least one terminal, reactive olefinically unsaturated group. Macromers typically contain unsaturation levels between 0.1 to 2 mol per mol of polyol, preferably 0.8 mol to 1.2 mol per mol of polyol. The use and function of these macromers is described, for example, in U.S. Pat. Nos. 4,454,255, 4,458,038 and 4,460,715. During the free-radical polymerization, the macromers are built into the copolymer chain. This results in formation of block copolymers having a polyol block and a polymer block containing the used olefinically unsaturated monomers, which in the interface of continuous phase and disperse phase act as phase compatibilizers and suppress agglomeration of the SAN polymer polyol particles. The olefinically unsaturated group can be inserted into an existing polyol by reaction with an organic compound having both olefinically unsaturation and a group reactive with an active hydrogen containing group such as carboxyl, anhydride, isocyanate, epoxy, and the like. Suitable organic compounds having both olefinically unsaturation and a group reactive with an active hydrogen containing group are maleic acid, malic anhydrides, fumaric acid, fumaric anhydrides, butadiene monoxide, glycidyl methacrylate, allyl alcohols, isocyanatoethyl methacrylate, 3-isopropenyl-1,1-dimethylbenzyl isocyanate, and the like. A further route is the preparation of a polyol by alkoxylation of ethylene oxide, propylene oxide and butylene oxide using starter molecules having hydroxyl groups and ethylenic unsaturation. Examples of such macromers are described, for example, in WO 01/04178, US 249274 and U.S. Pat. No. 6,013,731.

Preformed stabilizer, or stabilizer containing seeds, can also be used as described in U.S. Pat. Nos. 4,242,249, 4,550,194, 4,997,857, 5,196,476, US 2006/0025491. Preformed stabilizers are described to improve SAN polymer polyol stability with lower viscosity at higher solid content. The preformed stabilizer may precipitate from the solution during the reaction to form a solid. The particle size of the solid is small, thereby the formed particles can function as seed in the SAN polymer polyol process. Preformed stabilizers are prepared by reacting the macromer, with the olefinically unsaturated monomers in presence of the free radical initiator in the carrier polyol, optionally an organic solvent, optionally a moderator, to form a copolymer, i.e. a preformed stabilizer.

The free-radical polymerization initiators, moderators, organic solvents, macromers and preformed stabilizers can be present in the SAN polymer polyol with respective preferred amounts in between 0.01 wt.-% to 25 wt.-%, based on the total weight of the SAN polymer polyol.

The SAN polymer polyols can be prepared by continuous, semi-batch and batch processes. Temperature for free-radical polymerization reaction for preparing the SAN polymer polyol, owing to the reaction rate and half-life of the initiators, is in between 70° C. to 150° C. and pressure is up to 2 MPa. Preferred reaction conditions for preparing the SAN polymer polyols are temperature in between 80° C. to 140° C. and pressure up to 1.5 MPa. The product is typically vacuum stripped by known methods, such as but not limited to, vacuum distillation, and can be stabilized by the addition of compounds such as, but not limited to, di-tert-butyl-para-cresol. The SAN polymer polyols can be further filtered to remove any formed large particles.

The SAN polymer polyols particle distribution has a maximum at from 0.05 μm to 8.0 μm, preferably in between 0.1 μm to 4.0 μm, more preferably in between 0.2 μm to 3.0 μm, most preferably in between 0.2 μm to 2.0 μm.

Commercially available SAN polymer polyols available under the tradename, such as but not limited to, Lupranol® from BASF can also be used for the purpose of the present invention.

In another preferred embodiment, the component C) comprises a PHD polymer modified polyol. PHD polymer modified polyols are usually prepared by in-situ polymerization of an isocyanate mixture with a diamine and/or hydrazine in a polyol, preferably a polyether polyol. Methods for preparing PHD polymer modified polyols are described in, for example, U.S. Pat. Nos. 4,089,835 and 4,260,530.

In yet another preferred embodiment, the component C) comprises a PIPA polymer modified polyol. PIPA polymer modified polyols are usually prepared by the in-situ polymerization of an isocyanate mixture with a glycol and/or glycol amine in a polyol. Methods for preparing PIPA polymer modified polyols are described in, for example, U.S. Pat. Nos. 4,293,470 and 4,374,209.

The polymer solid content in PHD or PIPA polymer modified polyol is in between 3 wt.-% to 30 wt.-%, while the hydroxyl number is in between 15 mg KOH/g to 80 mg KOH/g.

Stabilizers

Stabilizers, if present, for rigid PU foams are predominantly silicon-based compounds such as silicone oils and organosilicone-polyether copolymers, such as polydimethyl siloxane and polysiloxane-polyether copolymers, e.g. polyether modified polydimethyl siloxane. Other suitable selections include silica particles and silica aerogel powders, as well as organic surfactants such as nonylphenol ethoxylates and VORASURF™ 504, which is an ethylene oxide/butylene oxide block copolymer having a relatively high molecular weight.

Particularly preferred stabilizers are polysiloxane-polyether copolymers. The bonding of the polyether chains in these copolymers can be realized through SiC or SiOC linkages. The SiOC-linked copolymers are stable in neutral or amine basic environment but are gradually hydrolysed in the presence of Lewis acids, such as tin catalysts and also by mineral acids. The SiC-linked copolymers are chemically stable in both amine basic and slightly acidic environment. Variations in the surfactant properties of these copolymers are obtained by altering the overall polysiloxane-polyether ratio, by varying the ethylene oxide-propylene oxide ratio in the polyether chains, and by the type of end groups by which the polyether chains are capped, which are mainly OH, O-alkyl or ester group. Commercially available surfactant products sold under tradenames, such as, DABCO™ and TEGOSTAB™ fall under this category.

The amount of stabilizers, as described hereinabove, can be preferably up to 100 wt.-%, based on the total weight of the respective component, preferably based on the total weight of the component C).

Catalysts

Preferred catalysts for component C) include metal salts and organometallics selected from the group of tin-, titanium-, zirconium-, hafnium-, bismuth-, zinc-, aluminium- and iron compounds, such as tin organic compounds, preferably tin alkyls, such as dimethyltin or diethyltin, or tin organic compounds based on aliphatic carboxylic acids, preferably tin diacetate, tin dilaurate, dibutyl tin diacetate, dibutyl tin dilaurate, bismuth compounds, such as bismuth alkyls or related compounds, or iron compounds, preferably iron-(II)-acetylacetonate or metal salts of carboxylic acids, such as tin-II-isooctoate, tin dioctoate, titanium acid esters or bismuth-(Ill)-neodecanoate.

Particularly preferred are bismuth compounds and organobismuth compounds, more particularly organobismuth compounds. Commercially available organobismuth compounds can also be employed, such as but not limited to, Coscat® from Vertellus.

The preferred amount of catalysts in component C) is in between 0.01 wt.-% to 99 wt.-%, based on the total weight of the component C).

Polyether Polyols

Preferred polyols in the component C) is a mixture of polyether polyol (iii) having an average functionality in between 3.0 to 4.0 and a hydroxyl number in between 300 mg KOH/g to 400 mg KOH/g, and a polyether polyol (iv) having an average functionality in between 2.5 to 6.0 and a hydroxyl number in between 40 mg KOH/g to 200 mg KOH/g. The polyether polyols (iii) and (iv) are selected from the preferred embodiments of the polyether polyols listed hereinabove.

Polyester Polyols

Preferred polyester polyols in the component C) have an average functionality in between 2.0 to 5.0, more preferably in between 2.0 to 4.0 and a hydroxyl number in between 30 mg KOH/g to 250 mg KOH/g, more preferably in between 100 mg KOH/g to 200 mg KOH/g. These polyester polyols are selected from the preferred embodiments of the polyester polyols listed hereinabove.

It is preferred, that mixing of component C) with A) leads to phase separation or chemical degradation and that the mass ratio of components A): C) is between >0:1 and 1: >0, e.g. between 0.0001:1 and 1:0.0001. Preferably the mass ratio of components A): C) is at least 0.25:1, more preferred at least 0.5:1 and most preferred at least 1:1. Within this embodiment, it is more preferred that component (C) comprises a polymer polyol and/or a stabilizer and/or a catalyst as compound(s) leading to phase separation or chemical degradation upon mixing with component A), and in particular that component (C) comprises a polymer polyol and/or a stabilizer as compound(s) leading to phase separation or chemical degradation upon mixing with component A).

Mixing Process and Mixing Device

The present invention is also capable of handling more than three, e.g. four, five, six or seven, separate streams as well, i.e. the present invention describes a multicomponent processing technique. Hereinafter, the present process may be interchangeably also referred to as a multicomponent process.

The presently claimed multicomponent process differs from the existing two-component system essentially in terms of the handling of incompatible and immiscible compounds. The incompatible and immiscible compounds are fed separately into the mixing device. That is, to say, that in addition to the stream comprising the polyol component, such as the first stream comprising component A), and the stream comprising the isocyanate component, such as the second stream comprising the component B), the multicomponent process comprises at least one other separate stream comprising at least one incompatible and immiscible compound, such as the third stream comprising the component C) as described herein. Thus, by incorporation of at least one additional stream, such as the third stream, phase separation or chemical degradation due to the incompatible and immiscible components in the reaction mixture is prevented. This results in rigid PU foams with improved demold behavior, mechanical performance and/or improved thermal conductivities without compromising on other advantageous properties of rigid PU foams that are used as an insulation material, such as but not limited to, compressive strength, adhesion, low brittleness and flowability.

Thus, when more than three streams are present, each separate stream can comprise at least one component, which may or may not be different from components A), B) or C). For instance, the fourth stream can have a component D) comprising the compounds disclosed herein. However, it is preferred that the additional stream comprises at least one component which is different from A), B) and C).

Accordingly, in an embodiment the process for producing rigid PU foam comprises at least the step of:

(S1) preparing the reaction mixture by feeding at least three separated streams into the mixing device, wherein
(A) the first stream comprises at least one component A), wherein component A) comprises at least one first isocyanate reactive compound,
(B) the second stream comprises at least one component B), wherein component B) comprises at least one isocyanate,
(C) the third stream comprises at least one component C) which is different from both components A) and B), and
(D) the fourth stream comprises at least one component D) which is different from components A), B) and C),
wherein at least one blowing agent and at least one catalyst is present in at least one of the components A), B), C) and D);

whereby mixing of component C) with A) and/or B) and/or D) leads to phase separation or chemical degradation.

Suitable temperatures for rigid PU foam processing are well known to the person skilled in the art. In an embodiment, in the mixing device and/or the individual streams, a temperature in between 10° C. to 50° C., preferably 15° C. to 40° C. can be maintained. However, each stream can be maintained at a different temperature and each stream does not necessarily have the same temperature. For instance, the temperature of the first and second streams can be 20° C., while that of the third stream can be 30° C.

In an embodiment, feeding of the streams into the mixing device is conducted preferably by means of pumps, which can operate at low-pressure or high-pressure, preferably at high pressure, in order to dispense the streams into the mixing device. Mixing within the mixing devices can be achieved among others by simple static mixer, low-pressure dynamic mixers, rotary element mixer as well as high-pressure impingement mixer. Mixing can be controlled by suitable means known to the person skilled in the art, for instance by simply switching on and off or even by a process control software equipped with flow meters, so that parameters, such as mixing ratio or temperature can be controlled.

In the present context, the term “low pressure” refers to pressure in between 0.1 MPa to 5 MPa, while “high pressure” refers to pressure above 5 MPa, preferably in between 5 MPa to 26 MPa.

In a preferred embodiment, the at least three separated streams are, independently of each other, at high pressure i.e. the pressure conditions prevalent in the mixing device, as described hereinabove. Thus, the at least three separated streams can also be referred to as at least three separated high pressure streams. The at least three separated streams, independently of each other, are at pressure in between 5 MPa to 26 MPa.

By the term “separated”, it is meant that the streams are fed into the mixing device separately and there is no prior mixing of the said streams. However, within the mixing device, the at least three separated streams can be pre-mixed.

The reaction mixture in step (S1), as described hereinabove, is prepared by feeding the streams separately into the mixing device. Preferably, the mixing device of the present invention comprises a high pressure mixing chamber, wherein simultaneous mixing of all the components by introducing three separated streams, as described hereinabove, takes place. Such mixing devices are well known to the person skilled in the art and therefore do not limit the present invention. For instance, U.S. Pat. Nos. 4,314,963 A, 7,240,689 B2, 8,833,297 B2 describe such multicomponent mixing devices.

In an embodiment, the mixing device comprises:
(a) high pressure pumps to feed the streams,
(b) a high pressure mixing chamber in which the components, as described hereinabove, are mixed,
(c) a first feed line fitted to the high pressure mixing chamber through which the first stream is introduced into the mixing chamber,
(d) a second feed line fitted to the high pressure mixing chamber through which the second stream is introduced into the mixing chamber, and
(e) a third feed line fitted to the high pressure mixing chamber through which the third stream is introduced into the mixing chamber.

Optionally, the mixing device, as described hereinabove, can further comprise at least one measurement and control unit for establishing the pressures of each feed lines in the mixing chamber.

In a preferred embodiment, mixing via high-pressure impingement can be done preferably by simultaneous combination of the separated streams within the mixing chamber using high pressure pumps for the entry of the separated streams, preferably via nozzles. Suitable nozzles for feeding the streams in the mixing chamber are well known to the person skilled in the art.

In another embodiment, mixing can be achieved in a subsequent manner such that at least two streams within the mixing device are pre-mixed shortly before being fed into the mixing chamber. For instance, the pre-mixing of the streams can be carried out at a separation of preferably less than 2 m from the mixing chamber by injecting one stream into another stream at high pressure by opening a valve, with or without further requirement of any mixing devices, as described hereinabove. The separation between the end of pre-mixing of streams and final mixing of all the streams in the mixing chamber is more preferably less than 50 cm and most preferably less than 20 cm, so that incompatibility of the separated streams does not affect the final product quality.

Commercially available mixing devices, such as but not limited to, TopLine® HK 650/650/45P from Hennecke GmbH can also be employed for the present invention. For example, the mixing device MT 18-4 from Hennecke can be applied for the multicomponent processing, as described hereinabove. This mixing device can simultaneously inject up to four streams into the mixing chamber. From the mixing chamber, the reaction mixture flows into a 90° offset outlet pipe. This leads to a facilitated mixing with calm output of the mixture. The reaction mixture discharges in a laminar and splash-free way into the open mold. The mixing device offers a laminar output with injection into open molds in a range from 125 to 600 cm³/s.

In another embodiment, suitable mixing means can also be installed upstream the mixing device, as described hereinabove, wherein the compounds within the respective components can be pre-mixed, prior to feeding the mixing chamber as at least three separated streams-first, second and third stream. These mixing means are well known to the person skilled in the art and therefore do not limit the present invention. Example of suitable mixing means can be, such as but not limited to, static mixers. In an exemplary embodiment, the first stream comprising at least the component A) comprising the first isocyanate reactive compound, catalysts, blowing agents, chain extenders and/or cross linkers, stabilizers and additives can be pre-mixed in the static mixer, prior to feeding into the mixing device. Similarly, other components can also be pre-mixed.

The reaction mixture of step (S1), as described hereinabove, is injected into a cavity, wherein foaming of the mixture occurs. By the term “cavity”, it is referred to an empty or hollow space of any geometry having at least one open side from which the reaction mixture can be injected to form the foam. Suitable examples of cavities are, such as but not limited to, empty or hollow spaces in pipes, refrigerators, freezers and insulation boards. By the term “injected”, it is referred to pouring or spraying the reaction mixture into the cavity, thereby resulting in foaming.

The multicomponent processing, as described hereinabove, can be continuous or discontinuous depending on the final application of the rigid PU foam. For instance, the continuous process is preferred for sandwich panels, while the discontinuous process is essentially for pour-in-place applications such as insulation materials such as insulation boards, water heaters, pipes, refrigerators, freezers, transport boxes, batteries, trucks or trailers, as described hereinbelow.

The rigid PU foam produced by the process, as described hereinabove, shows improved demold performance and/or improved thermal conductivities without compromising on other advantageous properties of rigid PU foams that are used as an insulation material, such as but not limited to, compressive strength, adhesion, low brittleness and flowability. In particular, the rigid PU foams showcase improved demold performance, i.e. very short demold time, which makes significantly reduced cycle time possible. Additionally, the multicomponent processing allows for industrial scale production of the rigid PU foam by overcoming the incompatibility and immiscibility in the mixture, which is prevalent in the state of the art. The rigid PU foam produced may be open cell or closed cell, preferably the rigid PU foam is a closed cell foam.

Another aspect of the present invention relates to the rigid PU foam obtained by the process described hereinabove. The rigid PU foam, due to its insulation properties, is formed into insulation boards, water heaters, pipes, refrigerators, freezers, transport boxes, batteries, trucks or trailers.

Yet another aspect of the present invention relates to use of the rigid PU foam, as described hereinabove, as insulation material. This insulation material is comprised by insulation boards, water heaters, pipes, refrigerators, freezers, transport boxes, batteries, trucks or trailers.

Still another aspect of the present invention relates to use of the polymer polyol for preparing the rigid PU foam, as described hereinabove, as insulation material. In other words, the component C) comprising the polymer polyols as one of the compounds for preparing the rigid PU foam is used as insulation material. This insulation material is comprised by insulation boards, water heaters, pipes, refrigerators, freezers, transport boxes, batteries, trucks or trailers.

Yet another aspect of the present invention relates to insulation boards, water heaters, pipes, refrigerators, freezers, transport boxes, batteries, trucks or trailers comprising the rigid PU foam, as described hereinabove.

Still another aspect of the present invention relates to a method of insulating an enclosed space, comprising the step of applying the rigid PU foam, as described hereinabove. The enclosed space is comprised by insulation boards, water heaters, pipes, refrigerators, freezers, transport boxes, batteries, trucks or trailers. The term “enclosed space” herein refers to empty or hollow space in a geometry wherein the rigid PU foam is injected.

### Embodiments

In the following, there is provided a list of embodiments to further illustrate the present disclosure without intending to limit the disclosure to the specific embodiments listed below.
1. A process for producing a rigid polyurethane foam comprising at least the step of:
   (S1) preparing a reaction mixture by feeding at least three separated streams into a mixing device, wherein
      (A) a first stream comprises at least one component A), wherein component A) comprises at least one first isocyanate reactive compound,
      (B) a second stream comprises at least one component B), wherein component B) comprises at least one isocyanate, and
      (C) a third stream comprises at least one component C) which is different from both components A) and B),
      wherein at least one blowing agent and at least one catalyst is present in at least one of the components A), B) and C);
   whereby mixing of component C) with A) and/or B) leads to phase separation or chemical degradation.
2. The process according to embodiment 1, further comprising
   (S2) injecting the reaction mixture obtained in step (S1) into a cavity.
3. The process according to embodiment 1 or 2, wherein the process is a discontinuous process.
4. The process according to one or more of embodiments 1 to 3, wherein the first isocyanate reactive compound is selected from the group consisting of polyether polyols, polyester polyols, polyether-ester polyols and mixtures thereof.
5. The process according to one or more of embodiments 1 to 4, wherein the at least one component A) further comprises at least one compound selected from the group consisting of chain extenders and/or cross linkers, stabilizers, additives and mixtures thereof.
6. The process according to one or more of embodiments 1 to 5, wherein the at least one component B) further comprises at least one compound selected from the group consisting of stabilizers, additives and mixtures thereof.
7. The process according to one or more of embodiments 1 to 6, wherein the at least one component C) which is different from both components A) and B) comprises at least one compound selected from the group consisting of polymer polyols, polyether polyols, polyester polyols, polyether-ester polyols, stabilizers, additives, isocyanates, catalysts and mixtures thereof.
8. The process according to embodiment 7, wherein the component C) comprises polymer polyols.
9. The process according to embodiment 7, wherein the component C) comprises polyether polyols.
10. The process according to embodiment 7, wherein the component C) comprises polyether polyols and polymer polyols.
11. The process according to embodiment 7, wherein the component C) comprises polyether polyols and blowing agents.
12. The process according to embodiment 7, wherein the component C) comprises polyester polyols and additives.
13. The process according to embodiment 7, wherein the component C) comprises polyether polyols and stabilizers.
14. The process according to embodiment 7, wherein the component C) comprises stabilizers.
15. The process according to one or more of embodiments 7 to 15, wherein the polymer polyols are selected from the group consisting of styrene-acrylonitrile (SAN) polymer polyols, polyurea suspension (PHD) polymer modified polyols and polyisocyanate polyaddition (PIPA) polymer modified polyols.
16. The process according to embodiment 15, wherein the polymer polyol is styrene-acrylonitrile (SAN) polymer polyol.
17. The process according to embodiment 16, wherein the amount of styrene-acrylonitrile (SAN) polymer polyol used within the component C) is up to 100 wt.-%.
18. The process according to embodiment 17, wherein the amount of styrene-acrylonitrile (SAN) polymer polyol used within the component C) is from 0.5 wt.-% to 70 wt.-%.
19. The process according to embodiment 17, wherein the amount of styrene-acrylonitrile (SAN) polymer polyol used within the component C) during the production of rigid polyurethane foam for use in refrigeration equipment is from 3 wt.-% to 70 wt.-%.
20. The process according to embodiment 17, wherein the amount of styrene-acrylonitrile (SAN) polymer polyol used within the component C) during the production of rigid polyurethane foams for use in sandwich components is from 0.5 to 35% by weight.
21. The process according to one or more of embodiments 15 to 20, wherein the styrene-acrylonitrile (SAN) polymer polyol particle distribution has a maximum at from 0.05 μm to 8 μm.
22. The process according to one or more of embodiments 15 to 21, wherein the styrene-acrylonitrile (SAN) polymer polyol is prepared by in-situ polymerization of ethylenically unsaturated monomers in polyether alcohols having an average functionality of from 2.0 to 8.0 and having a hydroxy value in the range from 20 to 800 mg KOH/g, obtainable by an addition reaction of alkylene oxides onto H-functional starter substances, the starter substances having been selected from the group comprising polyfunctional alcohols, sugar alcohols, aliphatic amines, and aromatic amines.
23. The process according to one or more of embodiments 15 to 21, wherein the styrene-acrylonitrile (SAN) polymer polyol is prepared by in-situ polymerization of ethylenically unsaturated monomers in polyether alcohols which are obtained by an addition reaction of alkylene oxides onto toluenediamine, using basic catalysis.
24. The process according to one or more of embodiments 15 to 21, wherein the styrene-acrylonitrile (SAN) polymer polyol is prepared by in-situ polymerization of ethylenically unsaturated monomers in polyether alcohols which are obtained by an addition reaction of alkylene oxides onto trimethylolpropane, using basic catalysis or catalysis by multimetal cyanide complexes.
25. The process according to embodiment 15, wherein the polymer polyol is a polyurea suspension (PHD) polymer modified polyol.
26. The process according to embodiment 25, wherein the PHD polymer modified polyol is prepared by in-situ polymerization of an isocyanate mixture with a diamine and/or hydrazine in a polyol, preferably a polyether polyol.
27. The process according to embodiment 25 or 26, wherein the PHD polymer modified polyol has an OH value in between 15 to 80 mg KOH/g.
28. The process according to embodiment 15, wherein the polymer polyol is a polyisocyanate polyaddition (PIPA) polymer modified polyol.
29. The process according to embodiment 28, wherein the PIPA polymer modified polyol is prepared by in-situ polymerization of an isocyanate mixture with a glycol and/or glycol amine in a polyol, preferably a polyether polyol.
30. The process according to embodiment 28 or 29, wherein the PIPA polymer modified polyol has an OH value in between 15 to 80 mg KOH/g.
31. The process according to one or more of embodiments 5 to 30, wherein the stabilizer is a polysiloxane-polyether copolymer.
32. The process according to one or more of embodiments 1 to 31, wherein the isocyanate has an average functionality of at least 2.0; preferably in between 2.0 to 3.0; more preferably in between 2.5 to 3; most preferably 2.7.
33. The process according to embodiment 32, wherein the isocyanate is selected from the group consisting of aliphatic and aromatic isocyanates.
34. The process according to 33, wherein the aromatic isocyanate is selected from the group consisting of toluene diisocyanate; polymeric toluene diisocyanate, methylene diphenyl diisocyanate; polymeric methylene diphenyl diisocyanate, m-phenylene diisocyanate; 1,5-naphthalene diisocyanate; 4-chloro-1; 3-phenylene diisocyanate; 2,4,6-toluylene triisocyanate, 1,3-diisopropylphenylene-2,4-diisocyanate; 1-methyl-3,5-diethylphenylene-2,4-diisocyanate; 1,3,5-triethylphenylene-2,4-diisocyanate; 1,3,5-triisoproply-phenylene-2,4-diisocyanate; 3,3′-diethyl-bisphenyl-4,4′-diisocyanate; 3,5,3′,5′-tetraethyl-diphenylmethane-4,4′-diisocyanate; 3,5,3′,5′-tetraisopropyldiphenylmethane-4,4′-diisocyanate; 1-ethyl-4-ethoxyphenyl-2,5-diisocyanate; 1,3,5-triethyl benzene-2,4,6-triisocyanate; 1-ethyl-3,5-diisopropyl benzene-2,4,6-triisocyanate, tolidine diisocyanate, 1,3,5-triisopropyl benzene-2,4,6-triisocyanate and mixtures thereof.
35. The process according to 34, wherein the isocyanate is polymeric methylene diphenyl diisocyanate.
36. The process according to one or more of embodiments 5 to 35, wherein the additives are selected from the group consisting of alkylene carbonates, carbonamides, pyrrolidones, fillers, flame retardants, dyes, pigments, IR absorbing materials, UV stabilizers, plasticizers, antistats, fungistats, bacteriostats, hydrolysis control agents, antioxidants, cell regulators, and mixtures thereof.
37. The process according to one or more of embodiments 1 to 36, wherein the at least three separated streams, independently of each other, are at a pressure in between 5 MPa to 26 MPa.
38. The process according to one or more of embodiments 1 to 37, wherein the mixing device comprises a high pressure mixing chamber into which the at least three separated streams are introduced simultaneously or into which two streams of the at least three streams are introduced after pre-mixing.
39. A rigid polyurethane foam obtained by the process according to one or more of embodiments 1 to 38.
40. The rigid polyurethane foam according to embodiment 39, wherein the rigid polyurethane foam is formed into insulation boards, water heaters, pipes, refrigerators, freezers, transport boxes, batteries, trucks or trailers.
41. Use of the rigid polyurethane foam according to embodiment 39 or as obtained by the process according to one or more of embodiments 1 to 38 as insulation material.
42. The use according to embodiment 39, wherein the insulation material is comprised by insulation boards, water heaters, pipes, refrigerators, freezers, transport boxes, batteries, trucks or trailers.
43. Use of a polymer polyol for preparation of a rigid polyurethane foam according to embodiment 39 or as obtained by the process according to one or more of embodiments 1 to 38 as insulation material.
44. The use according to embodiment 41, wherein the insulation material is comprised by insulation boards, water heaters, pipes, refrigerators, freezers, transport boxes, batteries, trucks or trailers.
45. Insulation boards, water heaters, pipes, refrigerators, freezers, transport boxes, batteries, trucks or trailers comprising the rigid polyurethane foam according to embodiment 39 or as obtained by the process according to one or more of embodiments 1 to 38.
46. A method of insulating an enclosed space, comprising the step of applying a rigid polyurethane foam according to embodiment 39 or as obtained by the process according to one or more of embodiments 1 to 38.
47. The method according to embodiment 44, wherein the enclosed space is comprised by insulation boards, water heaters, pipes, refrigerators, freezers, transport boxes, batteries, trucks or trailers.

### Examples

The present invention is illustrated by the non-restrictive examples which are as follows:

### Examples and Comparative Examples

Polyols, Isocyanates, Blowing Agents, Additives and Other Raw Materials

POLYOL

| | |
|---|---|
| Polyol P1 | Polyether polyol based on sucrose, glycerine and propylene oxide (PO); OH |
| | value = 425 mg KOH/g, functionality = 6.0 |
| Polyol P2 | Polyether polyol based on sucrose, glycerine and PO; OH value = 450 mg |
| | KOH/g, functionality = 5.2 |
| Polyol P3 | Polyether polyol based on sorbitol, glycerine and PO; OH value = 490 mg |
| | KOH/g, functionality = 5.0 (e.g. Lupranol ® 3422) |
| Polyol P4 | Polyether polyol based on vicinal toluenediamine (TDA) and PO; OH |
| | value = 399 mg KOH/g, functionality = 3.9 |
| Polyol P5 | Polyether polyol based on vicinal TDA, PO and ethylene oxide (EO); OH |
| | value = 160 mg KOH/g, functionality = 3.9 |
| Polyol P6 | Polyether polyol based on glycerine, PO and EO; OH value = 56 mg KOH/g, |
| | functionality = 2.7 |
| Polyol P7 | Polyether polyol based on sucrose, glycerine and PO; OH value = 42.8 mg |
| | KOH/g, functionality = 5.8 to 6.0 |
| Polyol P8 | Polyether polyol based on glycerine, PO and EO; OH value = 158 mg KOH/g, |
| | functionality = 3.0 |
| Polyol P9 | Polyether polyol based on glycerine and PO; OH value = 400 mg KOH/g, |
| | functionality = 3.0 |
| Polyol P10 | Polyether polyol based on sorbitol, PO and EO. Following alkoxylation, the |
| | polyol was modified using 3-isopropenyl-1,1-dimethylbenzyl isocyanate (1.5 |
| | mole equivalent. OH value = 16.5 mg KOH/g |
| Polyol P11 | Polyether polyol based on glycerine, PO and EO; OH value = 35 mg KOH/g, |
| | functionality = 2.7 |
| Polyol PP1 | Bimodal SAN polymer polyol derived from carrier polyol (Polyol P6), macromer |
| | (Polyol P10), Polyol PP4, moderator (dodecanethiol), azo-initiator, monomers |
| | styrene and acrylonitrile (ratio 2:1, styrene:acrylonitrile), solid content of 45 wt.-%, |
| | D50 of 0.73 pm and OH value = 30 mg KOH/g |
| Polyol PP2 | Monomodal SAN polymer polyol derived from carrier polyol (Polyol P5), |
| | macromer (Polyol P10), moderator (dodecanethiol), azo-initiator, monomers |
| | styrene and acrylonitrile (ratio 2:1, styrene:acrylonitrile), solid content of 45 wt.-%, |
| | D50 of 0.49 pm and OH value = 88 mg KOH/g |
| Polyol PP3 | Bimodal SAN polymer polyol derived from carrier polyol (Polyol P11), |
| | macromer (Polyol P10), Polyol PP4, moderator (dodecanethiol), azo-initiator, |
| | monomers styrene and acrylonitrile (ratio 2:1, styrene:acrylonitrile), solid |
| | content of 45 wt.-%, D50 of 0.86 μm and OH value = 20 mg KOH/g |
| Polyol PP4 | Monomodal SAN polymer polyol derived from carrier polyol (Polyol P6), |
| | macromer (Polyol P10), moderator (dodecanethiol), azo-initiator, monomers |
| | styrene and acrylonitrile (ratio 2:1, styrene:acrylonitrile), solid content of 45 wt.-%, |
| | D50 of 0.60 μm and OH value = 30 mg KOH/g |
| Polyol PE1 | Polyester polyol based on phthalic anhydride, oleic acid and diethylene glycol; |
| | OH value = 195 mg KOH/g, functionality = 2.0 |

ISOCYANATE (I)

| | |
|---|---|
| Isocyanate I1 | Polymer MDI with NCO content of 31.5 wt.-%, e.g. Lupranat M20S from BASF |

BLOWING AGENT (BA)

| | |
|---|---|
| BA1 | Cyclopentane (CP95) having purity >95%, e.g. from Haltermann Carless |
| | Deutschland GmbH |
| BA2 | Solstice LBA; HFO-1233zd from Honeywell |

STABILIZER (S)

| | |
|---|---|
| S1 | Silicon surfactant from Evonik; Tegostab ® B84204 |
| S2 | Silicon surfactant from Evonik; Tegostab ® B8499 (Tegostab ® B8481 or |
| | Dabco ® DC5357 is also possible) |

CATALYST (Cat)

| | |
|---|---|
| CatF (mixture | F1: Dimethylcyclohexylamine |
| of F1-F4) | F2: Bis(2-dimethylaminoethyl)ether |
| | F3: Tris(dimethylaminopropyl)hexahydro-1,3,5-triazin |
| | F4: Dimethylbenzylamine |
| CatG | Organobismuth compound (Coscat ® 83 catalyst from Vertellus) |

ADDITIVE (Ad)

| | |
|---|---|
| Ad1 | Propylene carbonate |
| Ad2 | Diethyl malonate |
| Ad3 | Castor oil; OH value = 160 mg KOH/g, functionality = 3.0 |

P: Polyether polyols;
PP: Polymer polyols;
PE: Polyester polyols;
I: Isocyanate;
BA: blowing agents;
S: silicon stabilizer;
Cat: catalysts and mixtures of catalysts;
Ad: Additives
General SAN polymer polyol preparation (Polyol PP2 & PP4)

The preparation description relates to SAN polymer polyols PP2 and PP44. The polyols were prepared in a continuously stirred reactor. The carrier polyol (46 wt.-% of the total amount of carrier polyol) and macromer (8 wt.-% of the total amount of macromer) were pre-charged in the reactor. Further reactants were continuously fed into the reactor as pre-made mixtures. The temperature of the mixture was kept at 125° C. Mixture X contained monomers and moderator (feeding time 150 min), mixture Y contained remaining carrier polyol and initiator (feeding time 165 min) and mixture Z (10 min delay, feeding time 23 min). The crude product was vacuum distilled to remove volatile compounds.

Analytical methods used for the raw materials and respective blended components
Water content by DIN 51777
OH value by DIN 53240
Amine value by DIN 16945
NCO content by DIN EN ISO 14896

Viscosity Determination

Polyol viscosity was determined at 25° C. in accordance with DIN EN ISO 3219 using a Rheotec RC 20 rotary viscometer and the CC 25 Din spindle (spindle diameter: 12.5 mm, measuring cylinder inside diameter: 13.56 mm) at a shear rate of 50 l/s.

Particle Size Determination

Particle size analysis was carried out by laser diffraction using a Mastersizer® 2000 (Malvern Instruments Ltd). The particle size was given as D50 (volume distribution), i.e. 50% of particles have the notated size or smaller.

Determination of Pentane Solubility

To evaluate the pentane solubility, the polyol is mixed (Vollrath stirrer, 1500 rpm, 2 min stirring time) with the amount which was reported in the examples for blowing agents and the mixture was poured into a screw-top jar which was then closed. Following complete escape of gas bubbles, sample clarity was initially assessed at room temperature. If the sample was clear, it was subsequently cooled down in a water bath in increments of 1° C. and assessed for clarity 30 minutes after reaching the temperature setting.

General Procedure for Preparing the Reaction Mixture

The aforementioned raw materials were used to prepare a component A) and an additional component C) (all particulars in wt.-%). A blowing agent was added to component A) and/or C). A TopLine HK 650/650/45P high pressure mixing device MT18-4 from Hennecke GmbH, operating at an output rate of 250 g/s was used to mix the components A) and C), which (one and/or both) have been admixed with the blowing agents, with the requisite amount of the component B), to obtain a desired isocyanate index (see Table 1).

The temperature of components A) and B) were 20° C., while that of component C) was 30° C.

The reaction mixture was subsequently injected into molds, temperature regulated to 40° C., measuring 2000 mm×200 mm×50 mm and/or 400 mm×700 mm×90 mm and allowed to foam up therein. Overpacking was 14.5%, i.e., 14.5% more reaction mixture than needed to completely foam out the mold was used.

The start time, gel time and free rise density were determined by high-pressure mixing (using a high-pressure Puromat® PU 30/80 IQ) and introduction into a PE bag. In this process a certain amount of material is injected into a PE bag (diameter is ca. 30 cm). The start time is defined as the time between the start of injection and the beginning of the volume expansion of the reaction mixture. The gel time is the time between the start of the injection and the time strings can be pulled out of the reaction mixture. If no mechanical processing is possible (e.g., due to in homogeneities of the polyol component), the determination of start time, gel time and free-rise density was made by manual mixing the blended components manually in a cup (so called cup test). Here, all components are tempered at 20±0.5° C. and the respective amounts were poured into a cup. After addition of the isocyanate component, the reaction mixture was stirred. The start time is defined here as the time interval between the start of stirring and the beginning of the volume expansion of the reaction mixture by foaming. The gel time corresponds to the time from the beginning of the mixing until the time strings can be pulled out of the reaction mixture. To determine the free rise density in a cup test, the top of the foam is cut after final foam curing. The cut is exactly along the edge of the test vessel perpendicular to the direction of foam rise, so that the foam and the upper edge of the cup is in one plane. The content of the cup is weightened and the free rise density can be obtained

Procedure for Determining the Occurrence of Phase Separation/Chemical Degradation

To evaluate the occurrence of a possible phase separation or chemical degradation, all raw materials for a stream (A) comprising at least one component A) were mixed and stored in a test tube. If the sample was clear by visual inspection it was monitored over time. As long as there was no phase separation within the first 10 minutes by visual inspection it was stored for further 7 days and was evaluated by visual inspection again. To evaluate the stability in regard to chemical degradation of the different combined raw material a cup test was done in each case with the respective amount of Isocyanate 11 to evaluate the foaming behaviour, via determination of the string time/gel time or free rise density. Furthermore, the water content, acid value, OH value, amine value, NCO content or colour changes have been analysed. As long as no significant changes could be observed the raw materials were considered as compatible, i.e. the mixing of the raw materials does not lead to phase separation/chemical degradation. For demonstration purposes the evaluation of the compatibility of the component of inventive example 2 is described in detail. Mixing together polyol P1, P4, Ad 1, Cat F, S1, water, BA1 and PP2 led instantaneously to the formation of a colorless precipitate as can be seen in FIG. 1B. This raw material combination was considered as incompatible. Such formation of a precipitate renders further processing impossible since the precipitate leads to clogging of the device, bad mixing with the isocyanate component and inhomogeneous foaming.

Thermal Conductivity

Thermal conductivity was determined using a Taurus TCA300 DTX at a midpoint temperature of 10° C. To prepare the test specimens, the polyurethane reaction mixture was imported into a 2000×200×50 mm mold with 17.5% overpacking and demolded 4.5 min later. After aging for 24 hours under standard conditions, several foam cuboids (at positions 10, 900 and 1700 mm on the lower end of the Brett molding) measuring 200×200×50 mm are cut out of the center. The top and bottom sides were then removed to obtain test specimens measuring 200×200×30 mm.

Determination of Demolding Behavior

Demolding behavior was determined by measuring the postexpansion of foam bodies produced using a 700×400×90 mm box mold at a mold temperature of 45±2° C. as a function of demolding time and the degree of overpacking (OP), which corresponds to the ratio of overall apparent density/minimum fill density. Postexpansion was determined by measuring the foam cuboids after 24 h. The post-expansion depicts the swelling of the foam block in mm.

Minimum Fill Density for a Component Part/Free Rise Density

Minimum fill density was determined by importing just sufficient polyurethane reaction mixture into a mold measuring 2000×200×50 mm at a mold temperature of 45±2° C. to just fill the mold. Free rise density was determined by allowing the foaming polyurethane reaction mixture to expand in a plastic bag at room temperature. The density was determined on a cube removed from the center of the foam-filled plastic bag.

TABLE 1
Inventive (IE) and comparative (CE) rigid PU foam formulations

| | | | | | | | | | | | | | | | |
|---|---|---|---|---|---|---|---|---|---|---|---|---|---|---|---|
| IE 1 | IE 2 | IE 3 | CE 1 | CE 2 | IE 4 | IE 5 | CE 3 | IE 6 | IE 7 | IE 8 | IE 9 | CE 4 | IE 10 | CE 5 | IE 11 |

Component A)

| | | | | | | | | | | | | | | | | |
|---|---|---|---|---|---|---|---|---|---|---|---|---|---|---|---|---|
| Polyol P1 | 56.0 | 56.0 | 56.0 | 56.0 | 56.0 | 56.0 | 57.1 | 57.1 | 71.8 | 57.0 | 56.3 | — | — | — | — | 56.7 |
| Polyol P2 | — | — | — | — | — | — | — | — | — | — | — | 56.4 | 55.0 | — | — | — |
| Polyol P3 | — | — | — | — | — | — | — | — | — | — | — | — | — | 41.2 | 36.0 | |
| Polyol P4 | 33.3 | 33.3 | 33.3 | 33.3 | 33.3 | 33.3 | 34.4 | 34.4 | 14.2 | 22.7 | 33.3 | 25.0 | 24.3 | — | — | 33.1 |
| Polyol P5 | — | — | — | — | — | — | — | — | — | 11.4 | 2.6 | 12.4 | 12.0 | — | — | — |
| Polyol P8 | — | — | — | — | — | — | — | — | — | — | — | — | — | 26.6 | 35.8 | — |
| Polyol P9 | — | — | — | — | — | — | — | — | — | — | — | — | — | 3.4 | 3.0 | — |
| Ad1 | 2.2 | 2.2 | 2.2 | 2.2 | 2.2 | 2.2 | — | — | 2.8 | — | 2.2 | — | — | — | — | 2.2 |
| Ad2 | — | — | — | — | — | — | — | — | — | — | — | — | — | 3.4 | 3.0 | — |
| Ad3 | — | — | — | — | — | — | — | — | — | — | — | — | — | 13.7 | 12.0 | — |
| DPG° | — | — | — | — | — | — | — | — | — | — | — | 1.0 | 1.0 | — | — | — |
| CatF | 2.8 | 2.8 | 2.8 | 2.8 | 2.8 | 2.8 | 3.1 | 3.1 | 3.6 | 2.7 | 2.8 | 3.5 | 3.3 | 3.3 | 2.9 | 2.0 |
| S1 | 3.3 | 3.3 | 3.3 | 3.3 | 3.3 | 3.3 | 3.4 | 3.4 | 4.0 | 3.4 | — | — | 2.8 | 2.9 | 2.5 | 3.3 |
| Water | 2.4 | 2.4 | 2.4 | 2.4 | 2.4 | 2.4 | 2.0 | 2.0 | 3.6 | 2.8 | 2.8 | 1.7 | 1.6 | 5.5 | 4.8 | 2.7 |
| Total A | 100 | 100 | 100 | 100 | 100 | 100 | 100 | 100 | 100 | 100 | 100 | 100 | 100 | 100 | 100 | 100 |
| BA1 (added | 15.0 | 15.0 | 15.0 | 15.0 | 15.0 | 15.0 | 9.5 | — | 7.1 | 15.3 | 15.0 | — | — | — | — | 14.8 |
| to A) | | | | | | | | | | | | | | | | |
| BA2 (added | — | — | — | — | — | — | — | — | — | — | — | 31.3 | 30.0 | — | — | — |
| to A) | | | | | | | | | | | | | | | | |

Component C)

| | | | | | | | | | | | | | | | | |
|---|---|---|---|---|---|---|---|---|---|---|---|---|---|---|---|---|
| Polyol P4 | — | — | — | — | — | — | — | — | 68.0 | — | — | — | — | — | — | — |
| Polyol P5 | — | — | — | 100 | — | 50.0 | — | 46.0 | — | — | 70.0 | — | — | — | — | 97.6 |
| Polyol P6 | — | — | — | — | 100 | — | — | — | — | — | — | — | — | — | — | — |
| Polyol P7 | — | — | — | — | — | — | — | — | 32.0 | — | — | — | — | — | — | — |
| Polyol P8 | — | — | — | — | — | — | — | — | — | — | — | — | — | 20.0 | — | — |
| Polyol PP1 | 100 | — | — | — | — | 50.0 | 46.0 | — | — | — | — | — | — | 80.0 | — | — |
| Polyol PP2 | — | 100 | — | — | — | — | — | — | — | — | — | — | — | — | — | — |
| Polyol PP3 | — | — | 100 | — | — | — | — | — | — | — | — | — | — | — | — | — |
| Polyol PE1 | — | — | — | — | — | — | — | — | — | 83.0 | — | — | — | — | — | — |
| Ad1 | — | — | — | — | — | — | — | — | — | 17.0 | — | — | — | — | — | — |
| CatG | — | — | — | — | — | — | — | — | — | — | — | — | — | — | — | 2.1 |
| S2 | — | — | — | — | — | — | — | — | — | — | 30.0 | 3.0 | — | — | — | — |
| BA2 | — | — | — | — | — | — | 54.0 | 54.0 | — | — | — | — | — | — | — | — |
| Total C | 100 | 100 | 100 | 100 | 100 | 100 | 100 | 100 | 100 | 100 | 100 | 100 | 100 | 100 | 0 | 100 |
| BA1 (added | — | — | — | — | — | — | — | — | 29.0 | — | — | — | — | — | — | — |
| to C) | | | | | | | | | | | | | | | | |

Component B)

| | | | | | | | | | | | | | | | | |
|---|---|---|---|---|---|---|---|---|---|---|---|---|---|---|---|---|
| Isocyanate I1 | 100 | 100 | 100 | 100 | 100 | 100 | 100 | 100 | 100 | 100 | 100 | 100 | 100 | 100 | 100 | 100 |
| Mixing ratio* | 9:1 | 9:1 | 9:1 | 9:1 | 9:1 | 9:1 | 4:1 | 4:1 | 2:1 | 17:2 | 9:1 | 97:3 | 100:0 | 7:1 | 100:0 | 9:1 |
| NCO index^{#} | 120 | 120 | 120 | 120 | 120 | 120 | 120 | 120 | 120 | 120 | 120 | 119 | 119 | 114 | 114 | 120 |

Machine data

| | | | | | | | | | | | | | | | | |
|---|---|---|---|---|---|---|---|---|---|---|---|---|---|---|---|---|
| Start time | 5 | 5 | 5 | 4 | 4 | 4 | 4 | 4 | 4 | 4 | 4 | 4 | 4 | 9 | 7 | 4 |
| [s] | | | | | | | | | | | | | | | | |
| String time | 40 | 39 | 40 | 39 | 41 | 39 | 39 | 38 | 38 | 36 | 38 | 44 | 44 | 45 | 48 | 38 |
| [s] | | | | | | | | | | | | | | | | |
| Free room | 23.4 | 23.8 | 24.2 | 22.2 | 22.6 | 22 | 24.6 | 21.9 | 23.2 | 21.2 | 21.8 | 23.8 | 23.6 | 24.3 | 24.5 | 22.4 |
| density | | | | | | | | | | | | | | | | |
| [kg/m³] | | | | | | | | | | | | | | | | |
| Minimum filling | 31 | 31.7 | 31.8 | 30.0 | 30.3 | 29.8 | 32.6 | 29.5 | 32.3 | 28.6 | 29.5 | 29.4 | 29.9 | 32.7 | 32.3 | 30.7 |
| density | | | | | | | | | | | | | | | | |
| [kg/m³] | | | | | | | | | | | | | | | | |
| Thermal | 19.8 | 19.8 | 19.8 | 19.8 | 20.0 | 19.9 | 18.6 | 18.6 | 20.1 | 19.4 | 19.8 | 18.0 | 18.0 | 22.1 | 22.4 | 19.7 |
| conductivity | | | | | | | | | | | | | | | | |
| [mW/mK] | | | | | | | | | | | | | | | | |
| Adhesion | 4.5 | 3.0 | 4.3 | 5.0 | 8.5 | 3.6 | 5.1 | 5.1 | 4.8 | 6.5 | 5.2 | n.d. | n.d. | 10.2 | 14.5 | 4.0 |
| (mold: 45° C.) | | | | | | | | | | | | | | | | |
| [N] | | | | | | | | | | | | | | | | |

Post expansion [mm] at 17.5% overpacking

| | | | | | | | | | | | | | | | | | |
|---|---|---|---|---|---|---|---|---|---|---|---|---|---|---|---|---|---|
| 2.5 | min | 3.6 | 3.8 | 3.4 | — | — | 4.1 | 2.7 | — | 3.6 | — | — | — | — | — | — | — |
| 3 | min | 2.5 | 2.6 | 2.3 | 3.6 | 3.5 | 3.2 | 1.9 | 2.6 | 2.8 | 5.6 | 3.4 | 3.8 | 4.5 | — | — | — |
| 4 | min | 1.2 | 1.4 | 1.2 | 2.1 | 1.9 | 1.7 | 0.9 | 1.4 | 1.7 | 3.8 | 2.1 | 2.7 | 3.2 | — | — | 4.9 |
| 5 | min | — | — | — | 1.1 | 1.0 | — | — | 0.9 | — | 2.5 | 1.1 | 2.0 | 2.2 | — | — | 3.5 |
| 10 | min | — | — | — | — | — | — | — | — | — | — | — | — | — | 3.2 | 2.8 | — |
| 12 | min | — | — | — | — | — | — | — | — | — | — | — | — | — | 2.2 | 2.0 | — |
| 14 | min | — | — | — | — | — | — | — | — | — | — | — | — | — | 1.2 | 0.9 | — |

°DPG: dipropylene glycol
*Mixing ratio as the mixing ratio of [total A + BA]:[total C + BA]
^{#}NCO index: total A, total C and BA are considered as one isocyanate reactive component for the calculation of the NCO-index
P: Polyether polyols;
PP: Polymer polyols;
PE: Polyester polyols;
Ad: Additives;
Cat: catalysts and mixtures of catalysts;
S: silicon stabilizer;
BA: blowing agents

TABLE 2
Predominant pairs of incompatible raw materials (RM), i.e. pairs of
raw materials showing phase separation, for the inventive examples

| | IE 1 | IE 2 | IE 3 | CE 1 | CE 2 | IE 4 | IE 5 | CE 3 | IE 6 | IE 7 | IE 8 | IE 9 | CE 4 | IE 10 | CE 5 | IE 11 |
|---|---|---|---|---|---|---|---|---|---|---|---|---|---|---|---|---|
| RM 1 | P1 | P1 | P1 | — | — | P1 | P1 | — | P1 | P1 | P1 | P2 | — | P3 | — | water |
| RM 2 | PP1 | PP2 | PP3 | — | — | PP1 | PP1 | — | P7 | PE1 | S2 | S2 | — | PP1 | — | CatG |

As evident hereinabove, the inventive examples show quick demolding behaviour as the post expansion is significantly reduced (IE 1 to 3, IE 4 to 6, IE 8 to 10), Demolding can be achieved already after 2.5 mins based on the applied test set up (box mold with a thickness of 90 mm; e.g. IE 3 and IE 5). Moreover, post expansion can even be reduced for purely water-blown systems (IE 10), which can be applied e.g. for water heater insulation. Reduction in thermal conductivity, which leads to an improved lambda value is also evident in the above table (e.g. IE 7). Additionally, the properties of the rigid PU foam that is obtained by using the present invention are good and/or satisfactory so that the rigid PU foam can be used as an insulation material.

Furthermore, even water-sensitive metal catalysts based on organobismuth compounds can be applied without a change in reactivity (IE 11). Once component A and component B used in IE11 are mixed together and stored for one week at room temperature, a change of the reactivity can be observed (table 3). For example, the gel time resulting from the cup tests reveal significant differences, proving that a standard 2-component processing cannot be applied.

TABLE 3

| | Initial Cuptest | Cuptest after 7 days |
|---|---|---|
| | (3-component | (standard 2-component |
| | process) | process) |
| Start time [s] | 7 | 9 |
| Gel time [s] | 52 | 64 |
| Free density [g/L] | 26.6 | 27.1 |

Reworking of Example 3 of WO 99/60045 A1

The following compounds were used:

Polyol A: A rigid, aromatic, amine-group containing, propylene (PO)-based polyether polyol, having a hydroxyl value of 400 mg KOH/g (original 530 mg KOH/g);

Polyol B: A rigid glycerol initiated polyether polyol having a hydroxyl value of 160 mg KOH/g (original 250 g KOH/g);

PP-A: polymer polyol containing a base polyol Polyether polyol based on glycerine, PO and EO (0% primary OH group content) based on styrene and acrylonitrile (ratio 2:1, styrene:acrylonitrile) with a solid content of 45 wt.-% and a hydroxyl value of 30 mg KOH/g;

Silicon surfactant: Tegostab B8404 from Evonik (former Goldschmidt);

Dimethanol amine (DMEA);

Polycat 41 (trimerization catalyst);

TCPP: Tris(chloropropyl)phosphate

Water.

The result of the determination of a possible phase separation is shown in FIG. 2: PB: polyol blend, slightly yellow; C1: Cat1 blend; C2: Cat 2 blend; M: mixture of PB, C1 and C2

Mixture of polyol blend, Cat 1 blend and Cat 2 blend leads to homogeneous slightly yellow phase. The 3-component mixture M is still homogenous after one week storage at 25° C.

The result of the determination of a possible chemical degradation by cup test are shown in Table 4. The results are very close, so it can be concluded that no chemical degradation occurred.

TABLE 4

| | Initial Cuptest | Cuptest after 7 days |
|---|---|---|
| Start time [s] | 15 | 15 |
| Gel time [s] | 57 | 58 |
| Free density [g/L] | 24.9 | 24.6 |

1. A process for producing a rigid polyurethane foam, comprising:
(S1) preparing a reaction mixture by feeding at least three separated streams into a mixing device, wherein
(A) a first stream comprises at least one component A), wherein component A) comprises at least one first isocyanate reactive compound,
(B) a second stream comprises at least one component B), wherein component B) comprises at least one isocyanate, and
(C) a third stream comprises at least one component C) which is different from both components A) and B),
wherein at least one blowing agent and at least one catalyst is present in at least one of the components A), B) and C);
whereby mixing of component C) with A) and/or B) leads to phase separation or chemical degradation.

2. The process according to claim 1, further comprising:
(S2) injecting the reaction mixture obtained in (S1) into a cavity.

3. The process according to claim 1, wherein the process is a discontinuous process.

4. The process according to claim 1, wherein the at least one component A) further comprises at least one compound selected from the group consisting of chain extenders and/or cross linkers, stabilizers, additives and mixtures thereof.

5. The process according to claim 1, wherein the at least one component (B) further comprises at least one compound selected from the group consisting of stabilizers, additives and mixtures thereof.

6. The process according to claim 1, wherein the at least one component (C) which is different from both components A) and B) comprises at least one compound selected from the group consisting of polymer polyols, polyether polyols, polyester polyols, polyether-ester polyols, stabilizers, additives, catalysts and mixtures thereof.

7. The process according to claim 6, wherein the component C) comprises a polymer polyol.

8. The process according to claim 6, wherein the component C) comprises a polyether polyol and a polymer polyol.

9. The process according to claim 6, wherein the component C) comprises a stabilizer.

10. The process according to claim 1, wherein the at least three separated streams, independently of each other, are at a pressure in between 5 MPa to 26 MPa.

11. The process according to claim 1, wherein the mixing device comprises a high pressure mixing chamber into which the at least three separated streams are introduced simultaneously or into which two streams of the at least three streams are introduced after pre-mixing.

12. The process according to claim 1, wherein the rigid polyurethane foam prepared is a closed cell foam.

13. The process according to claim 1, wherein the reaction mixture is formed into at least one member selected from the group consisting of insulation boards, water heaters, pipes, refrigerators, freezers, transport boxes, batteries, trucks and trailers.

14. The process according to claim 1, wherein mixing of component C) with A) leads to phase separation or chemical degradation and the mass ratio of components C): A) is between >0:1 and 1: >0.
